(19) United States
(12) Patent Application Publication
(10) Pub. No.: US 2025/0384834 A1
(43) Pub. Date: Dec. 18, 2025

(54) DISPLAY DEVICE INCLUDING THE SAME, DISPLAY SYSTEM INCLUDING THE SAME, AND METHOD OF DRIVING THE SAME

(71) Applicant: Samsung Display Co., LTD., Yongin-si (KR)

(72) Inventors: Min Kyu WOO, Yongin-si (KR); Kyung Hoon CHUNG, Yongin-si (KR)

(73) Assignee: Samsung Display Co., LTD., Yongin-si (KR)

(21) Appl. No.: 19/193,253

(22) Filed: Apr. 29, 2025

(30) Foreign Application Priority Data
Jun. 17, 2024 (KR) 10-2024-0078201
Sep. 25, 2024 (KR) 10-2024-0130256

(51) Int. Cl. G09G 3/3233; G09G 3/32

(52) U.S. Cl. CPC G09G 3/3233; G09G 3/32; G09G 2300/0426; G09G 2300/043; G09G 2310/08; G09G 2320/0242

(57) ABSTRACT

A sub-pixel includes a first transistor including a gate electrode connected to a first node, a source electrode connected to a first power line, a body electrode connected to the source electrode, and a drain electrode connected to a second node, a second transistor between a third node and a data line and including a gate electrode connected to a first scan line, a third transistor connected to the first node and including a gate electrode connected to the third node, a fourth transistor between the first node and the second node and including a gate electrode connected to a second scan line, a first capacitor connected to the first node and a second power line, a second capacitor connected to the third node and a sweep line, and a light emitting element connected to the second node.

### CROSS-REFERENCE TO RELATED APPLICATION(S)

This application claims priority to and benefits of Korean Patent Applications No. 10-2024-0078201, filed on Jun. 17, 2024, and No. 10-2024-0130256, filed on Sep. 25, 2024, under 35 U.S.C. § 119, the entire contents of which are incorporated herein by reference.

### BACKGROUND

### 1. Technical Field

Embodiments of the disclosure relate to a display device including the same, and a method of driving the same.

### 2. Description of the Related Art

As information technology develops, the importance of a display device, which is a connection medium between a user and information, has been highlighted. In response to this, a use of a display device such as a liquid crystal display device and an organic light emitting display device is increasing.

A light emitting display device may include multiple pixels including one or more light emitting elements. The light emitting display device may display an image of various grayscales by varying a driving current flowing through the light emitting element.

However, in case that the driving current changes in a light emitting element that emits light of a specific wavelength band (for example, a green wavelength band), the wavelength band of the light emitted from the corresponding light emitting element may be shifted, and thus a problem in that a color coordinate is distorted may occur.

Accordingly, a technology for displaying an image of various grayscales by controlling a length of a period in which the driving current flows through the light emitting element while maintaining the size of the driving current supplied to the light emitting element is being studied.

### SUMMARY

Embodiments of the disclosure may provide a sub-pixel in which a problem in that a color coordinate is distorted is improved, a display device including the same, a display system including the same, and a method of driving the same.

According to an embodiment of the disclosure, a display device may include a sub-pixel. The sub-pixel may include a first transistor including a gate electrode connected to a first node, a source electrode connected to a first power line to which a first power voltage is applied, a body electrode connected to the source electrode, and a drain electrode connected to a second node, a second transistor that switches an electrical connection between a third node and a data line and including a gate electrode electrically connected to a first sub-scan line, a third transistor connected to the first node and including a gate electrode connected to the third node, a fourth transistor that switches an electrical connection between the first node and the second node and including a gate electrode connected to a second sub-scan line, a first capacitor including a first electrode electrically connected to the first node and a second electrode connected to a second power line to which a second power voltage is applied, a second capacitor including a first electrode electrically connected to the third node and a second electrode connected to a sweep line to which a sweep signal is applied, and a light emitting element connected between the second node and a third power line to which a third power voltage is applied.

The first power voltage may have one of a low level, a middle level, and a high level.

A driving current flowing in a direction from the first transistor to the light emitting element may be proportional to a square of a voltage difference between the middle level and the high level of the first power voltage.

In at least a portion of a period in which a second scan signal of a turn-on level is applied to the second sub-scan line, the first power voltage may have a low level, and in a remaining portion of the period in which the second scan signal of the turn-on level is applied to the second sub-scan line, the first power voltage may have a middle level.

In the period in which the second scan signal of the turn-on level is applied to the second sub-scan line and the first power voltage has the low level, a voltage of the first node may be initialized.

In the period in which the second scan signal of the turn-on level is applied to the second sub-scan line and the first power voltage has the middle level, a voltage in which a change of a threshold voltage of the first transistor may be reflected is stored in the first node.

In case that a first scan signal of a turn-on level is applied to the first sub-scan line, the third node and the data line may be electrically connected.

In a period in which the third power voltage transits from a high level to a low level and a voltage level of the sweep signal decreases from a high level to a low level, in case that a voltage of a turn-on level is applied to the third transistor, the first transistor may be turned off.

The sub-pixel may emit light having luminance according to a duration of time in which a driving current flows in a direction from the first transistor to the light emitting element.

The third transistor may be connected between the first power line and the first node. The third transistor may include a body electrode connected to the first power line.

The third transistor may be connected between the second power line and the first node. The third transistor may include a body electrode connected to a fourth power line.

Each of the first transistor, the third transistor, and the fourth transistor may include a P-type semiconductor.

The second transistor may include a P-type semiconductor. The second transistor may include a body electrode connected to the second power line.

The second transistor may include an N-type semiconductor. The second transistor may include a body electrode connected to a fourth power line.

According to an embodiment of the disclosure, the display device may further include a display panel in which a plurality of sub-pixels including the sub-pixel are disposed, a gate driver that supplies a first scan signal and a second scan signal to the plurality of sub-pixels, a sweep supply circuit that supplies the sweep signal to the plurality of sub-pixels, a data driver that supplies a data voltage to the plurality of sub-pixels, and a voltage generator that supplies the first power voltage, the second power voltage, and the third power voltage to the plurality of sub-pixels.

The voltage generator may be supplied with a driving voltage, a ground voltage, and a voltage control signal. The voltage generator may output the first power voltage having one of a low level, a middle level, and a high level in response to the voltage control signal.

According to an embodiment of the disclosure, a method of driving a display device may include applying a first power voltage of a low level to a source electrode and a body electrode of a driving transistor, and electrically separating a gate electrode and a drain electrode of the driving transistor from each other, applying the first power voltage of the low level to the source electrode and the body electrode of the driving transistor, and electrically connecting the gate electrode and the drain electrode of the driving transistor to each other, applying the first power voltage of a middle level to the source electrode and the body electrode of the driving transistor, and electrically connecting the gate electrode and the drain electrode of the driving transistor to each other, applying a data voltage to a first electrode of a sweep capacitor in case that the gate electrode and the drain electrode of the driving transistor are electrically separated from each other and a switching transistor is turned on, and applying the first power voltage of a high level to the source electrode and the body electrode of the driving transistor, and causing a light emitting element connected between the drain electrode of the driving transistor and a power line to emit light.

In the causing of the light emitting element to emit light, in case that a voltage level of a sweep signal applied to a second electrode of the sweep capacitor decreases from a high level to a low level, and an emission control transistor including a gate electrode connected to the first electrode of the sweep capacitor is turned on, a second power voltage may be applied to the gate electrode of the driving transistor, and the driving transistor may be turned off.

In the causing of the light emitting element to emit light, a driving current flowing through the light emitting element may be based on a wavelength band of light emitted from the light emitting element.

According to an embodiment of the disclosure, a display system may include a processor that outputs input image data, a display panel in which a plurality of sub-pixels are disposed, a gate driver that supplies a first scan signal and a second scan signal to the plurality of sub-pixels, a sweep supply circuit that supplies a sweep signal to the plurality of sub-pixels, a data driver that supplies a data voltage corresponding to the input image data to the plurality of sub-pixels, and a voltage generator that supplies a first power voltage, a second power voltage, and a third power voltage to the plurality of sub-pixels. At least one of the plurality of sub-pixels may include a first transistor including a gate electrode connected to a first node, a source electrode connected to a first power line to which the first power voltage is applied, a body electrode connected to the source electrode, and a drain electrode connected to a second node, a second transistor that switches an electrical connection between a third node and a data line to which the data voltage is applied and including a gate electrode to which the first sub-scan signal is applied, a third transistor connected to the first node and including a gate electrode connected to the third node, a fourth transistor that switches an electrical connection between the first node and the second node and including a gate electrode to which the second sub-scan signal is applied, a first capacitor including a first electrode electrically connected to the first node and a second electrode to which the second power voltage is applied, a second capacitor including a first electrode electrically connected to the third node and a second electrode to which the sweep signal is applied, and a light emitting element connected between the second node and a second power line to which the third power voltage is applied.

### BRIEF DESCRIPTION OF THE DRAWINGS

The above and other features of the disclosure will become more apparent by describing in further detail embodiments thereof with reference to the accompanying drawings, in which:

FIG. 1 is a schematic block diagram illustrating an embodiment of a display device according to embodiments of the disclosure;

FIG. 2 is a plan view illustrating an embodiment of a display panel of FIG. 1;

FIG. 3 is a schematic block diagram illustrating an embodiment of one of the sub-pixels of FIG. 1;

FIG. 4 is a schematic diagram of a pixel according to embodiments of the disclosure;

FIG. 5 is a schematic diagram of an equivalent circuit of a sub-pixel according to embodiments of the disclosure;

FIG. 6 is a schematic timing diagram illustrating a method of driving a display device according to embodiments of the disclosure;

FIG. 7 is a schematic diagram illustrating a (1-1)-th period of FIG. 6;

FIG. 8 is a schematic diagram illustrating a (1-2)-th period of FIG. 6;

FIG. 9 is a schematic diagram illustrating a second period of FIG. 6;

FIG. 10 is a schematic diagram illustrating a third period of FIG. 6;

FIG. 11 is a schematic diagram illustrating a fourth period of FIG. 6;

FIG. 12 is a schematic system block diagram schematically illustrating a voltage generator according to embodiments of the disclosure;

FIG. 13 is a schematic diagram of an equivalent circuit of a sub-pixel according to embodiments of the disclosure;

FIG. 14 is a schematic diagram of an equivalent circuit of a sub-pixel according to embodiments of the disclosure;

FIG. 15 is a schematic diagram of an equivalent circuit of a sub-pixel according to embodiments of the disclosure;

FIG. 16 is a schematic diagram of a pixel according to embodiments of the disclosure;

FIG. 17 is schematic diagram of an equivalent circuit of a sub-pixel according to embodiments of the disclosure;

FIG. 18 is a schematic timing diagram illustrating a method of driving a display device according to embodiments of the disclosure;

FIG. 19 is a schematic timing diagram illustrating a method of driving a display device according to embodiments of the disclosure;

FIG. 20 is a schematic cross-sectional view illustrating an embodiment of the display panel of FIG. 2;

FIG. 21 is a schematic cross-sectional view illustrating another embodiment of the display panel of FIG. 2;

FIG. 22 is a plan view illustrating an embodiment of one of the pixels of FIG. 2;

FIG. 23 is a schematic cross-sectional view taken along line I-I′ of FIG. 22;

FIG. 24 is a schematic cross-sectional view taken along line II-II′ of FIG. 22;

FIG. 25 is a schematic block diagram illustrating an embodiment of a display system; and

FIGS. 26 to 29 are perspective views illustrating application examples of the display system of FIG. 25.

### DETAILED DESCRIPTION OF THE EMBODIMENTS

Hereinafter, embodiments according to the disclosure are described in detail with reference to the accompanying drawings. It should be noted that in the following description, only portions for understanding an operation according to the disclosure are described, and descriptions of other portions are omitted in order not to obscure the subject matter of the disclosure. In addition, the disclosure may be embodied in other forms without being limited to the embodiment described herein. However, the embodiment described herein is provided to describe in detail enough to readily implement the technical spirit of the disclosure to those skilled in the art to which the disclosure belongs.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Also, when an element is referred to as being “in contact” or “contacted” or the like to another element, the element may be in “electrical contact” or in “physical contact” with another element; or in “indirect contact” or in “direct contact” with another element.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

In the specification and the claims, the phrase “at least one of” is intended to include the meaning of “at least one selected from the group of” for the purpose of its meaning and interpretation. For example, “at least one of A and B” may be understood to mean “A, B, or A and B.” In the specification and the claims, the term “and/or” is intended to include any combination of the terms “and” and “or” for the purpose of its meaning and interpretation. For example, “A and/or B” may be understood to mean “A, B, or A and B.” The terms “and” and “or” may be used in the conjunctive or disjunctive sense and may be understood to be equivalent to “and/or.”

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

Various embodiments are described with reference to drawings schematically illustrating ideal embodiments. Accordingly, it will be expected that shapes may vary, for example, according to tolerances and/or manufacturing techniques. Therefore, the embodiments disclosed herein cannot be construed as being limited to shown specific shapes, and should be interpreted as including, for example, changes in shapes that occur as a result of manufacturing. As described above, the shapes shown in the drawings may not show actual shapes of areas of a device, and the embodiments are not limited thereto.

Unless otherwise defined or implied herein, all terms (including technical and scientific terms) used have the same meaning as commonly understood by those skilled in the art to which this disclosure pertains. It will be further understood that terms, such as those defined in commonly used dictionaries, should be interpreted as having a meaning that is consistent with their meaning in the context of the relevant art and should not be interpreted in an ideal or excessively formal sense unless clearly defined in the specification.

Hereinafter, embodiments of the disclosure are described in detail with reference to the attached drawings.

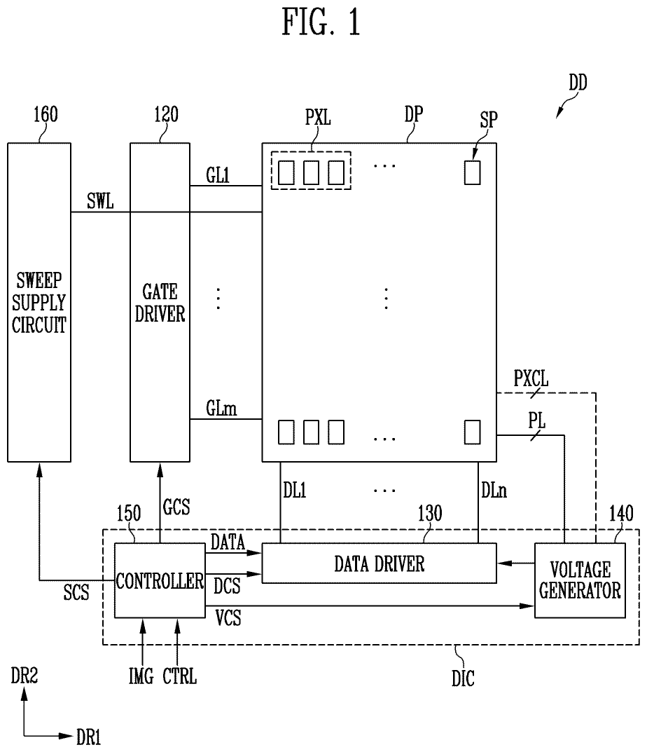

FIG. 1 is a schematic block diagram illustrating an embodiment of a display device DD according to embodiments of the disclosure.

Referring to FIG. 1, the display device DD may include a display panel DP, a gate driver 120, a data driver 130, a voltage generator 140, a controller 150, a sweep supply circuit 160, and the like.

The display panel DP may include multiple sub-pixels SP. The sub-pixels SP may be connected to the gate driver 120 through first to m-th gate lines GL1 to GLm (m is an integer equal to or greater than 1). The sub-pixels SP may be connected to the data driver 130 through first to n-th data lines DL1 to DLn (n is an integer equal to or greater than 1).

The sub-pixels SP may generate light of two or more colors. For example, each of the sub-pixels SP may generate light such as red light, green light, blue light, cyan light, magenta light, or yellow light.

Two or more sub-pixels among the sub-pixels SP may configure one pixel PXL. For example, the pixel PXL may include three sub-pixels as shown in FIG. 1. As described above, the pixel PXL may emit light of various colors and various luminances according to a combination of light emitted from the sub-pixels included in the pixel PXL.

The gate driver 120 may be connected to the sub-pixels SP arranged in a row direction through the first to m-th gate lines GL1 to GLm. The gate driver 120 may output gate signals to the first to m-th gate lines GL1 to GLm in response to a gate control signal GCS. In embodiments, the gate control signal GCS may include a start signal indicating a start of each frame, a horizontal synchronization signal, and the like.

The gate driver 120 may be disposed on a side of the display panel DP. However, embodiments of the disclosure are not limited thereto. For example, the gate driver 120 may be divided into two or more physically and/or logically divided drivers, and the drivers may be disposed on a side of the display panel DP and another side of the display panel DP opposite the side. As described above, the gate driver 120 may be disposed adjacent to the display panel DP in various shapes according to embodiments.

The data driver 130 may be connected to the sub-pixels SP arranged in a column direction through the first to n-th data lines DL1 to DLn. The data driver 130 may receive image data DATA and a data control signal DCS from the controller 150. The data driver 130 may operate in response to the data control signal DCS. In embodiments, the data control signal DCS may include a source start signal, a source shift clock, a source output enable signal, and the like.

The data driver 130 may receive voltages from the voltage generator 140. The data driver 130 may apply data signals having grayscale voltages corresponding to the image data DATA to the first to n-th data lines DL1 to DLn using the received voltages. In case that the gate signal is applied to each of the first to m-th gate lines GL1 to GLm, the data signals corresponding to the image data DATA may be applied to the data lines DL1 to DLn. Accordingly, the sub-pixels SP may generate light corresponding to the data signals, and the display panel DP may display an image.

In embodiments, the gate driver 120 and the data driver 130 may include complementary metal-oxide semiconductor (CMOS) circuit elements.

The voltage generator 140 may operate in response to a voltage control signal VCS from the controller 150. The voltage generator 140 may be configured to generate multiple voltages and provide the generated voltages to components of the display device DD, such as the gate driver 120, the data driver 130, and the controller 150. The voltage generator 140 may generate voltages by receiving an input voltage from an outside of the display device DD and regulating the received voltage.

The voltage generator 140 may generate two or more power voltages. The generated power voltages may be provided to the sub-pixels SP through power lines PL. In other embodiments, at least one of the first and second power voltages may be provided from the outside of the display device DD.

The voltage generator 140 may provide various voltages and/or signals. For example, the voltage generator 140 may provide one or more initialization voltages to the sub-pixels SP. For example, during a sensing operation for sensing electrical characteristics of transistors and/or light emitting elements of the sub-pixels SP, a reference voltage may be applied to the first to n-th data lines DL1 to DLn, and the voltage generator 140 may generate the reference voltage and transmit the reference voltage to the data driver 130. For example, during a display operation for displaying an image on the display panel DP, common pixel control signals may be applied to the sub-pixels SP, and the voltage generator 140 may generate the pixel control signals. In embodiments, the voltage generator 140 may provide the pixel control signals to the sub-pixels SP through pixel control lines PXCL. In FIG. 1, the pixel control lines PXCL are connected between the voltage generator 140 and the display panel DP, but embodiments are not limited thereto. For example, the pixel control lines PXCL may be connected between the gate driver 120 and the display panel DP, and the pixel control signals may be transmitted from the voltage generator 140 to the pixel control lines PXCL through the gate driver 120.

The sweep supply circuit 160 may provide a sweep signal to the display panel DP. The sweep signal may be, for example, a signal of which a voltage gradually increases over time. The sweep signal may be, for example, a signal of which a voltage gradually decreases over time. The sweep signal may be provided as a triangle wave. The sweep supply circuit 160 may provide a sweep signal to a sweep line SWL. The sweep line SWL may be connected to the sub-pixels SP. The sweep supply circuit 160 may provide the sweep signal to the sweep line SWL in response to a sweep control signal SCS received from the controller 150.

According to an embodiment, one sweep line SWL may be connected to multiple sub-pixels SP positioned in one row (or one pixel row). According to an embodiment, one sweep line SWL may be connected to multiple sub-pixels SP positioned in multiple rows (or multiple pixel rows).

The controller 150 may control overall operations of the display device DD. The controller 150 may receive input image data IMG and a control signal CTRL corresponding to the input image data IMG from the outside. The controller 150 may provide the gate control signal GCS, the data control signal DCS, the voltage control signal VCS, and the sweep control signal SCS, in response to the control signal CTRL.

The controller 150 may convert the input image data IMG suitable for the display device DD or the display panel DP and output the image data DATA. In embodiments, the controller 150 may output the image data DATA by aligning the input image data IMG suitable for the sub-pixels SP of a row unit.

Two or more components of the data driver 130, the voltage generator 140, and the controller 150 may be mounted on one integrated circuit. As shown in FIG. 1, the data driver 130, the voltage generator 140, and the controller 150 may be included in a driver integrated circuit DIC, and the data driver 130, the voltage generator 140, and the controller 150 may be functionally divided components in one driver integrated circuit DIC. In other embodiments, at least one of the data driver 130, the voltage generator 140, and the controller 150 may be provided as a component distinguished from the driver integrated circuit DIC.

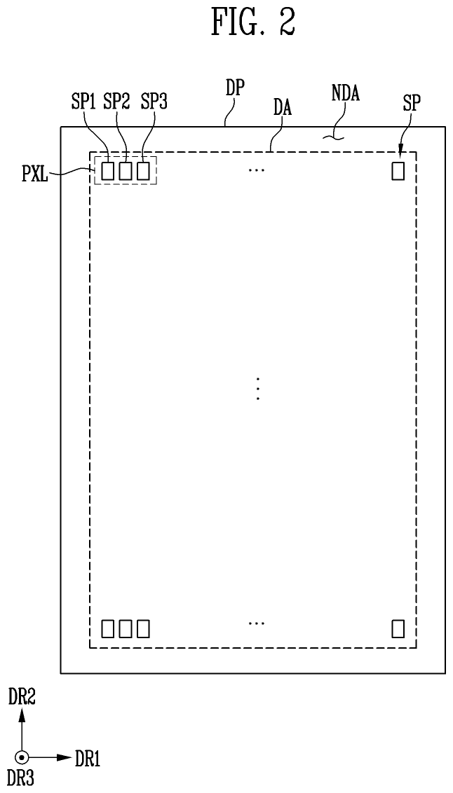

FIG. 2 is a plan view illustrating an embodiment of the display panel DP of FIG. 1.

Referring to FIG. 2, the display panel DP may include a display area DA and a non-display area NDA. The display panel DP may display an image through the display area DA. The non-display area NDA may be disposed adjacent to the display area DA.

The sub-pixels SP may be positioned in the display area DA. The sub-pixels SP may be arranged in a first direction DR1 and a second direction DR2 intersecting the first direction DR1. In an embodiment, the sub-pixels SP may be arranged in a matrix form along the first direction DR1 and the second direction DR2. In another embodiment, the sub-pixels SP may be arranged in a zigzag form along the first direction DR1 and the second direction DR2. An arrangement of the sub-pixels SP may vary according to embodiments. For example, the first direction DR1 may be the row direction, and the second direction DR2 may be the column direction. However, embodiments of the disclosure are not limited thereto.

Two or more sub-pixels among the sub-pixels SP may configure one pixel PXL. Referring to FIG. 2, the pixel PXL is shown as including three sub-pixels SP1, SP2, and SP3, but embodiments of the disclosure are not limited thereto. For example, the pixel PXL may include two sub-pixels. Hereinafter, for convenience of description, an embodiment that the pixel PXL includes the first to third sub-pixels SP1 to SP3 will be described.

Each of the first to third sub-pixels SP1 to SP3 may generate light of one of various colors, such as red, green, blue, cyan, magenta, and yellow. Hereinafter, for clarity and a concise description, an embodiment that the first sub-pixel SP1 is configured to generate light of a red color, the second sub-pixel SP2 is configured to generate light of a green color, and the third sub-pixel SP3 generates light of a blue color will be described.

Each of the first to third sub-pixels SP1 to SP3 may include at least one light emitting element configured to generate light. In embodiments, the light emitting elements of the first to third sub-pixels SP1 to SP3 may generate light of a same color. For example, the light emitting elements of the first to third sub-pixels SP1 to SP3 may generate light of a blue color. In other embodiments, the light emitting elements of the first to third sub-pixels SP1 to SP3 may generate light of different colors. For example, the light emitting elements of the first to third sub-pixels SP1 to SP3 may generate light of a red color, a green color, and a blue color, respectively.

As the display panel DP, a self-emission display panel such as a light emitting diode display panel (LED display panel) that uses a micro-scale or nano-scale of light emitting diode as a light emitting element, and an organic light emitting diode display panel (OLED panel) that uses an organic light emitting diode as a light emitting element may be used.

In the non-display area NDA, a component for controlling the sub-pixels SP may be disposed. Lines connected to the sub-pixels SP, for example, the first to m-th gate lines GL1 to GLm, the first to n-th data lines DL1 to DLn, the power lines PL, and the pixel control lines PXCL of FIG. 1, may be disposed in the non-display area NDA.

At least one of the gate driver 120, the data driver 130, the voltage generator 140, the controller 150, and the sweep supply circuit 160 of FIG. 1 may be disposed in the non-display area NDA of the display panel DP. In embodiments, the gate driver 120 and the sweep supply circuit 160 may be disposed in the non-display area NDA, the data driver 130, the voltage generator 140, and the controller 150 may be implemented as the driver integrated circuit DIC of FIG. 1 that is separate from the display panel DP, and the driver integrated circuit DIC may be connected to the lines disposed in the non-display area NDA. In other embodiments, the gate driver 120 may be implemented as one integrated circuit that is separate from the display panel DP together with the data driver 130, the voltage generator 140, and the controller 150. However, embodiments of the disclosure are not limited thereto.

The display area DA may have various shapes. In an embodiment, the display area DA may have a closed loop shape including straight and/or curved sides in a plan view. For example, the display area DA may have a shape such as a polygon, a circle, a semicircle, and an ellipse.

In embodiments, the display panel DP may have a flat display surface. In other embodiments, the display panel DP may have a display surface that is at least partially round. In embodiments, the display panel DP may be bendable, foldable, or rollable, and the display panel DP and/or a substrate of the display panel DP may include a material having a flexible property.

Each of the sub-pixels SP1, SP2, and SP3 may generate and emit light of a wavelength band. In order to provide a display panel DP having high display quality, it is advantageous for a wavelength band of light emitted from the sub-pixel SP to be maintained constant. In case that a current density of a driving current (or a size of the driving current) flowing in the sub-pixel SP is maintained constant, the wavelength band of light may be maintained constant. To this end, a method for improving display quality by displaying various luminances by controlling a time when the driving current flows in the sub-pixel SP while maintaining the driving current constant is proposed.

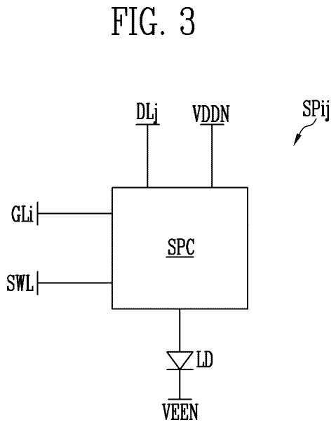

FIG. 3 is a schematic block diagram illustrating an embodiment of one of the sub-pixels SP of FIG. 1.

In FIG. 3, among the sub-pixels SP of FIG. 1, a sub-pixel SPij arranged in an i-th row (i is an integer equal to or greater than 1) and a j-th column (j is an integer equal to or greater than 1) is shown according to an embodiment.

Referring to FIG. 3, the sub-pixel SPij may include a sub-pixel circuit SPC and a light emitting element LD.

The light emitting element LD may be connected between a first power voltage node VDDN and a second power voltage node VEEN. The first power voltage node VDDN may be connected to one of the power lines PL of FIG. 1 and receive the first power voltage. The second power voltage node VEEN may be connected to another one of the power lines PL of FIG. 1 and receive the third power voltage. The first power voltage may have a voltage level higher than the third power voltage.

The light emitting element LD may be connected between an anode electrode and a cathode electrode. The anode electrode may be connected to the first power voltage node VDDN through the sub-pixel circuit SPC. For example, the anode electrode may be connected to the first power voltage node VDDN through one or more transistors included in the sub-pixel circuit SPC. The cathode electrode may be connected to the second power voltage node VEEN. The light emitting element LD may be configured to emit light according to a current flowing from the anode electrode to the cathode electrode.

The sub-pixel circuit SPC may be connected to an i-th gate line GLi among the first to m-th gate lines GL1 to GLm of FIG. 1, and a j-th data line DLj among the first to n-th data lines DL1 to DLn of FIG. 1. In response to a gate signal received through the i-th gate line GLi, the sub-pixel circuit SPC may control the light emitting element LD to emit light according to a data signal received through the j-th data line DLj. In embodiments, the sub-pixel circuit SPC may be connected to the sweep line SWL of FIG. 1.

For such operations, the sub-pixel circuit SPC may include circuit elements, for example, transistors and one or more capacitors.

The transistors of the sub-pixel circuit SPC may be P-type transistors and/or N-type transistors. In embodiments, the transistors of the sub-pixel circuit SPC may be a metal oxide silicon field effect transistor (MOSFET). In embodiments, the transistors of the sub-pixel circuit SPC may include at least one of an amorphous silicon semiconductor, a monocrystalline silicon, a polycrystalline silicon semiconductor, an oxide semiconductor, or the like.

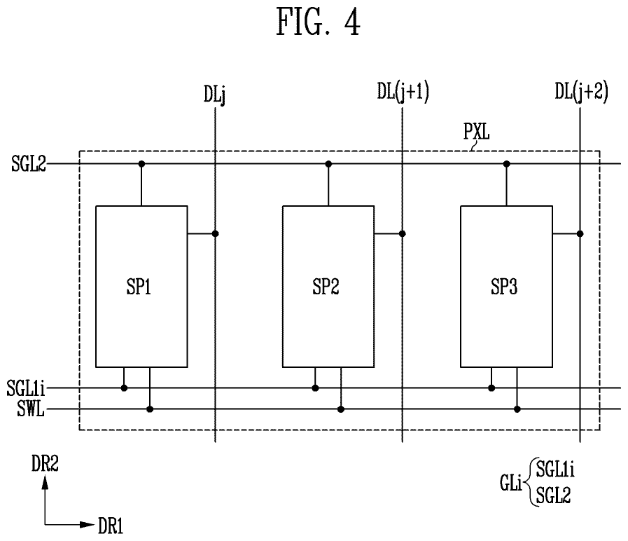

FIG. 4 is a schematic diagram of a pixel PXL according to embodiments of the disclosure.

Referring to FIG. 4, the pixel PXL according to embodiments of the disclosure may include the first to third sub-pixels SP1 to SP3.

The first to third sub-pixels SP1 to SP3 may be commonly connected to an i-th first sub-scan line SGL1i (hereinafter, also referred to as a first sub-scan line SGL1i), a second sub-scan line SGL2, and the sweep line SWL.

The first sub-pixel SP1 may be connected to the j-th data line DLj. The second sub-pixel SP2 may be connected to a (j+1)-th data line DL (j+1). The third sub-pixel SP3 may be connected to a (j+2)-th data line DL (j+2).

Below, for convenience of description, a configuration and the like of the sub-pixel are described based on the first sub-pixel SP1. A description of the first sub-pixel SP1 may also be applied to the second sub-pixel SP2 and the third sub-pixel SP3.

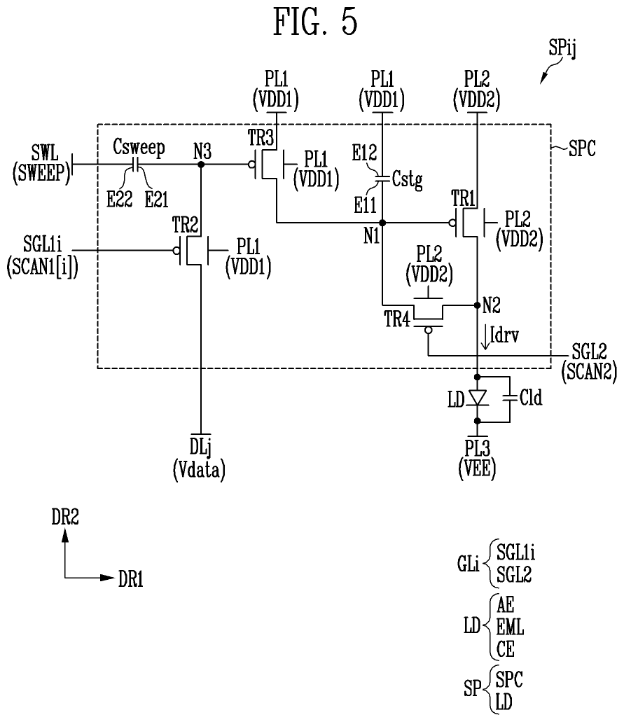

FIG. 5 is a schematic diagram of an equivalent circuit of a sub-pixel SPij according to embodiments of the disclosure.

Referring to FIG. 5, the sub-pixel SPij according to embodiments of the disclosure may include the sub-pixel circuit SPC and the light emitting element LD.

The sub-pixel circuit SPC according to embodiments of the disclosure may include two or more switching elements and one or more storage elements. For example, the switching element may be implemented as a transistor. The For example, the storage element may be implemented as a capacitor.

Referring to FIG. 5, an embodiment that includes four transistors and two capacitors is shown as the sub-pixel circuit SPC. For example, the sub-pixel circuit SPC according to embodiments of the disclosure may include first to fourth transistors TR1 to TR4 and first and second capacitors Cstg and Csweep.

The first transistor TR1 may be configured to control a length of a time in which a driving current Idrv flows through the light emitting element LD. The first transistor TR1 may include a gate electrode connected to a first node N1, a source electrode connected to a second power line PL2, a drain electrode connected to a second node N2, and a body electrode connected to the second power line PL2. A second power voltage VDD2 may be applied to the second power line PL2. In the embodiment, the source electrode and the body electrode of the first transistor TR1 may be electrically connected to each other and may be commonly connected to the second power line PL2. The first transistor TR1 may be turned on during a period in which a voltage of a turn-on level is applied to the first node N1, to control the length of the period in which the driving current Idrv flows through the light emitting element LD. The first transistor TR1 may be referred to as a driving transistor TR1. In embodiments of the disclosure, according to the length of the period in which the driving current Idrv flows through the light emitting element LD, the sub-pixel SPij may emit light with different luminances. An area where the first transistor TR1 and the second power line PL2 are connected may correspond to the first power voltage node VDDN of FIG. 3 described above.

The second transistor TR2 may be configured to switch an electrical connection between a third node N3 and the j-th data line DLj (hereinafter, also abbreviated as a data line DLj). The second transistor TR2 may include a gate electrode connected to the i-th first sub-scan line SGL1i (hereinafter, also abbreviated as a first sub-scan line SGL1i). A first scan signal SCAN1[i] may be applied to the first sub-scan line SGL1i. The second transistor TR2 may be turned on in response to the first scan signal SCAN1[i] of a turn-on level. In case that the second transistor TR2 is turned on, the j-th data line DLj (hereinafter, also abbreviated as the data line DLj) and the third node N3 may be electrically connected, and thus a data signal Vdata may be applied to the third node N3. The second transistor TR2 may further include a body electrode connected to a first power line PL1. A first power voltage VDD1 may be applied to the first power line PL1. The second transistor TR2 may be referred to as a switching transistor TR2.

The third transistor TR3 may be configured to switch an electrical connection between the first power line PL1 and the first node N1. The third transistor TR3 may include a gate electrode connected to the third node N3. The third transistor TR3 may be configured to electrically connect the first power line PL1 and the first node N1 in response to a voltage of a turn-on level is applied to the third node N3. The third transistor TR3 may further include a body electrode connected to the first power line PL1. The third transistor TR3 may be referred to as an emission control transistor TR3.

The fourth transistor TR4 may be configured to switch an electrical connection between the first node N1 and the second node N2. The fourth transistor TR4 may include a gate electrode connected to the second sub-scan line SGL2. The second sub-scan line SGL2 may be commonly connected to multiple pixel rows including the i-th pixel row. The fourth transistor TR4 may further include a body electrode connected to the second power line PL2. The fourth transistor TR4 may be referred to as a compensation transistor TR4.

The first capacitor Cstg may be configured to maintain a voltage applied to the first node N1. The first capacitor Cstg may include a first electrode E11 connected to the first node N1 and a second electrode E12 connected to the first power line PL1. The first electrode E11 and the second electrode E12 of the first capacitor Cstg may face each other. The first capacitor Cstg may be an intentionally and physically formed capacitor, not a parasitic capacitor. The first capacitor Cstg may be referred to as a storage capacitor Cstg.

The second capacitor Csweep may be configured to maintain a voltage difference between the third node N3 and the sweep line SWL. The second capacitor Csweep may include a first electrode E21 connected to the third node N3 and a second electrode E22 connected to the sweep line SWL. The first electrode E21 and the second electrode E22 may face each other. As a level of the sweep signal SWEEP fluctuates in a state in which the data voltage Vdata is applied to the third node N3, a voltage of the third node N3 may fluctuate while having a waveform similar to a waveform of the sweep signal SWEEP. In case that the voltage of the third node N3 becomes equal to a turn-on level voltage of the third transistor TR3, the third transistor TR3 may be turned on, the first node N1 may be electrically connected to the first power line PL1, and thus the first power voltage VDD1 may be applied to the first node N1. The second capacitor Csweep may be an intentionally and physically formed capacitor, not a parasitic capacitor. The second capacitor Csweep may be referred to as a sweep capacitor Csweep.

The light emitting element LD may emit light by the driving current Idrv. The light emitting element LD may include a first electrode (for example, an anode electrode AE) connected to the second node N2 and a second electrode (for example, a cathode electrode CE) connected to a third power line PL3. A third power voltage VEE may be applied to the third power line PL3. A light emitting layer EML may be implemented as an inorganic light emitting layer including an inorganic material, an organic light emitting layer including an organic material, or the like, but embodiments of the disclosure are not limited thereto. The light emitting element LD may have a parasitic capacitor Cld component having the anode electrode AE and the cathode electrode CE as a side electrode and another side electrode, respectively. In case that a voltage difference between the anode electrode AE and the cathode electrode CE of the light emitting element LD is less than a threshold voltage of the light emitting element LD, a charge may be charged in the parasitic capacitor Cld, and the light emitting element LD may not emit light. For example, in case that a voltage of the third power voltage VEE increases, a voltage applied to the cathode electrode of the light emitting element LD may relatively increase, the driving current Idrv may not flow, and the light emitting element LD may not emit light. A second electrode to which the light emitting element LD and the third power line PL3 are connected may correspond to the second power voltage node VEEN of FIG. 3 described above.

Referring to FIG. 5, each of the first to fourth transistors TR1 to TR4 may include a P-type semiconductor. A transistor including a P-type semiconductor may be turned on in response to a low level of signal and turned off in response to a high level of signal. However, embodiments of the disclosure are not limited thereto. For example, at least one of the first to fourth transistors TR1 to TR4 may include an N-type semiconductor. A transistor including an N-type semiconductor may be turned on in response to a high level of signal and turned off in response to a low level of signal.

In an embodiment, each of the first to fourth transistors TR1 to TR4 may be implemented as a field-effect transistor (FET). For example, each of the first to fourth transistors TR1 to TR4 may be implemented as a metal-oxide-semiconductor FET (MOSFET).

Referring to FIG. 5, the first transistor TR1 and the fourth transistor TR4 may include a body electrode to which a second power voltage VDD2 is applied. Accordingly, a turn-on timing of the first transistor TR1 and the fourth transistor TR4 may be controlled by changing a voltage level of the second power voltage VDD2. As will be described through a timing diagram described below, in case that the second power voltage VDD2 has a low level, a voltage level of the first node N1 and the second node N2 may be initialized to the low level of the second power voltage VDD2. In case that the second power voltage VDD2 has a middle level, a voltage in which a threshold voltage change of the first transistor TR1 is compensated (or reflected) may be stored in the first node N1.

In FIGS. 4 and 5, the second power line PL2, the sweep line SWL, and the second sub-scan line SGL2 are shown as being commonly connected to the sub-pixels SP disposed in multiple pixel rows. However, embodiments of the disclosure are not limited thereto, and the second power line PL2, the sweep line SWL, and the second sub-scan line SGL2 may be individually connected to each of the pixel rows. In the embodiment, the second power voltage VDD2, the sweep signal SWEEP, and the second scan signal SCAN2 may be written in a pixel row unit. Below, for convenience of description, an embodiment in which the second power line PL2, the sweep line SWL, and the second sub-scan line SGL2 are commonly connected to the pixel rows is described, but embodiments of the disclosure are not limited thereto.

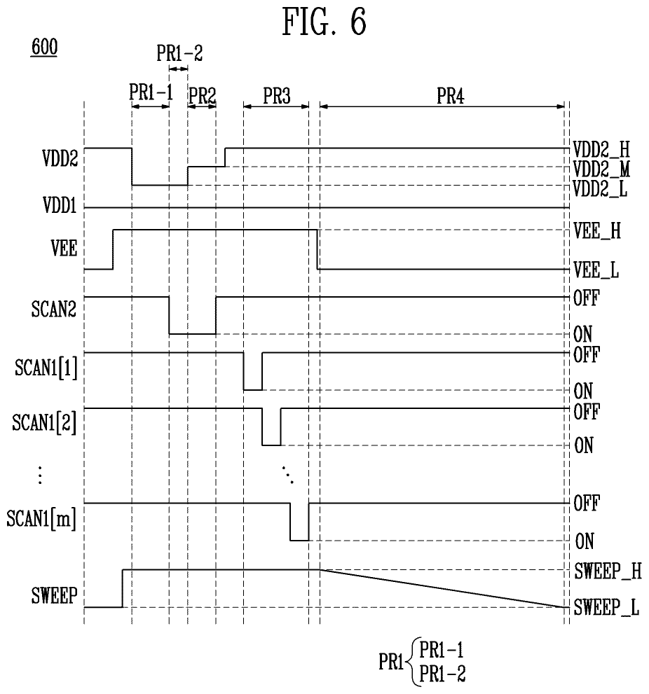

FIG. 6 is a schematic timing diagram illustrating a method 600 of driving a display device according to embodiments of the disclosure.

The method 600 of driving the display device according to embodiments of the disclosure may include a first period PR1, a second period PR2, a third period PR3, and a fourth period PR4. The first period PR1 may correspond to an initialization period. The second period PR2 may correspond to a compensation period. The third period PR3 may correspond to a writing period. The fourth period PR4 may correspond to a light emitting period.

During the first to fourth periods PR1 to PR4, the first power voltage VDD1 may have a constant level. The first power voltage VDD1 may be a turn-off level of the first transistor TR1 (refer to FIG. 5) described above. For example, the first power voltage VDD1 may be a high level voltage. In case that the first power voltage VDD1 is applied to the first node N1, the first transistor TR1 may be turned off. For example, a level of the first power voltage VDD1 may be set to be equal to a high level VDD2_H of the second power voltage VDD2. However, embodiments of the disclosure are not limited thereto.

The first period PR1 may include a (1-1)-th period PR1-1 and a (1-2)-th period PR1-2. The (1-1)-th period PR1-1 and the (1-2)-th period PR1-2 may be distinguished based on a timing that the second scan signal SCAN2 transits from a turn-off level OFF to a turn-on level ON.

In the (1-1)-th period PR1-1, the second power voltage VDD2 may have a low level VDD2_L, the third power voltage VEE may have a high level VEE_H, the second scan signal SCAN2 may have the turn-off level OFF, first scan signals SCAN1[1] to SCAN1[m] may have the turn-off level OFF, and the sweep signal SWEEP may have a high level SWEEP_H.

In the (1-2)-th period PR1-2, the second power voltage VDD2 may have the low level VDD2_L, the third power voltage VEE may have the high level VEE_H, the second scan signal SCAN2 may have the turn-on level ON, the first scan signals SCAN1[1] to SCAN1[m] may have the turn-off level OFF, and the sweep signal SWEEP may have the high level SWEEP_H.

In the second period PR2, the second power voltage VDD2 may have a middle level VDD2_M, the third power voltage VEE may have the high level VEE_H, the second scan signal SCAN2 may have the turn-on level ON, the first scan signals SCAN1[1] to SCAN1[m] may have the turn-off level OFF, and the sweep signal SWEEP may have the high level SWEEP_H.

In the third period PR3, the second power voltage VDD2 may have the high level VDD2_H, the third power voltage VEE may have the high level VEE_H, the second scan signal SCAN2 may have the turn-off level OFF, the first scan signals SCAN1[1] to SCAN1[m] may sequentially have the turn-on level ON, and the sweep signal SWEEP may have the high level SWEEP_H.

In the fourth period PR4, the second power voltage VDD2 may have the high level VDD2_H, the third power voltage VEE may have a low level VEE_L, the second scan signal SCAN2 may have the turn-off level OFF, the first scan signals SCAN1[1] to SCAN1[m] may have the turn-off level OFF, and the sweep signal SWEEP may gradually decrease from the high level SWEEP_H to the low level SWEEP_L.

Below, the method 600 of driving the display device according to FIG. 6 is described in relation to the sub-pixel SPij (refer to FIG. 5).

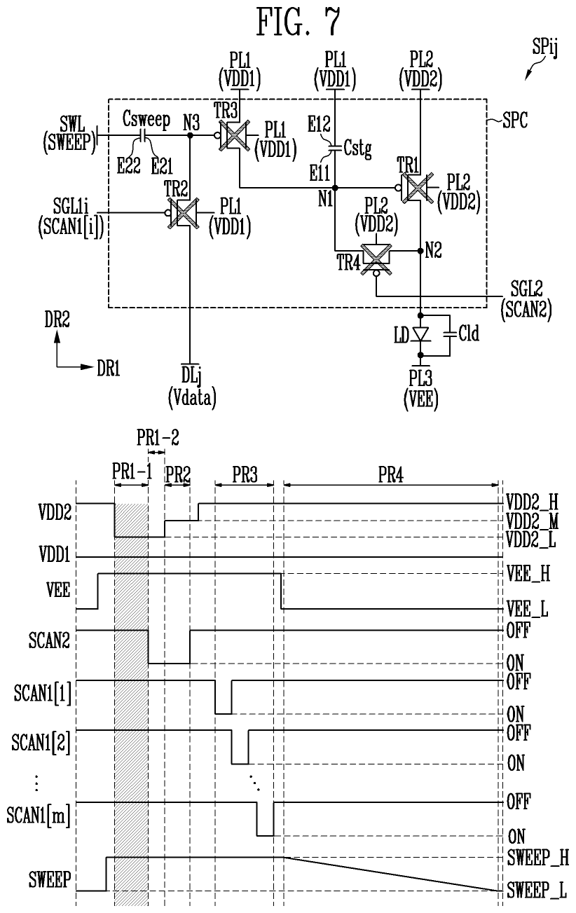

FIG. 7 is a schematic diagram illustrating the (1-1)-th period PR1-1 of FIG. 6.

In the (1-1)-th period PR1-1, the second power voltage VDD2 may have the low level VDD2_L. Accordingly, the second power voltage VDD2 of the low level VDD2_L may be applied to the body electrode of the first transistor TR1 and the fourth transistor TR4.

The third power voltage VEE may have the high level VEE_H. The driving current may not flow through the light emitting element LD by the third power voltage VEE of the high level VEE_H.

The second scan signal SCAN2 may have the voltage of the turn-off level OFF. Accordingly, the fourth transistor TR4 may be in a turn-off state.

The first scan signals SCAN1[1] to SCAN[m] may have the voltage of the turn-off level OFF. Accordingly, the second transistor TR2 may be in a turn-off state.

The sweep signal SWEEP may have the high level SWEEP_H.

In the (1-1)-th period PR1-1, the voltage level of the first node N1 may be equal to the first power voltage VDD1.

In the (1-1)-th period PR1-1, a voltage of the second node N2 may be initialized as a level of the body electrode shown in Formula 1 below drops to the low level VDD2_L in a state in which the first transistor TR1 and the fourth transistor TR4 are turned off.

$$VN 2 = VDD2\_L + {V}_{th} \_diode \qquad [ Formula 1 ]$$

In the Formula 1, VN2 may be a voltage of the second node N2, VDD2_L may be a voltage applied to the body electrode of each of the first transistor TR1 and the fourth transistor TR4 in the (1-1)-th period PR1-1, and Vₜₕ_diode may be a threshold voltage of a parasitic diode.

Vₜₕ_diode is described in more detail as follows. A first parasitic diode may be formed between a first electrode (for example, an electrode connected to the second node N2) of the first transistor TR1 and the body electrode of the first transistor TR1. The first parasitic diode may have a first threshold voltage. For convenience, a size of the first threshold voltage may be referred to as “Vth1”. A second parasitic diode may be formed between a first electrode (for example, an electrode connected to the second node N2) of the fourth transistor TR4 and the body electrode of the fourth transistor TR4. The second parasitic diode may have a second threshold voltage. For convenience, a size of the second threshold voltage is referred to as “Vth2”. Vth_diode may be a smaller value of the first threshold voltage Vth1 and the second threshold voltage Vth2. For example, the voltage of the second node N2 may be lowered until a current does not flow in a direction of the body electrode in both of the first parasitic diode and the second parasitic diode. The voltage of the second node N2 may be lowered to a value obtained by adding the smaller value of Vth1 and Vth2 to VDD2_L which is a voltage of the body electrode. Accordingly, the voltage of the second node N2 may be decreased to a value of VDD2_L+V_{th_diode} and initialized.

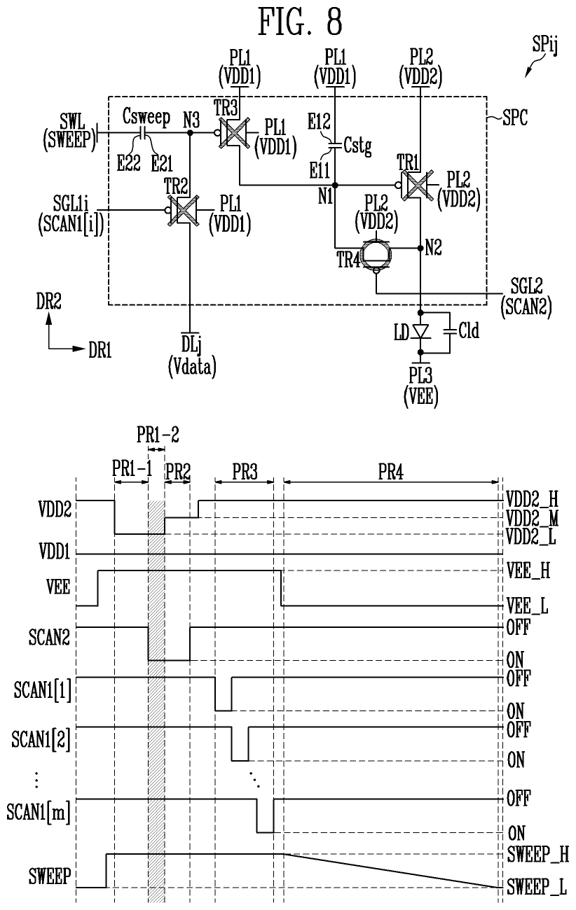

FIG. 8 is a schematic diagram illustrating the (1-2)-th period PR1-2 of FIG. 6.

Referring to FIG. 8, the second scan signal SCAN2 of the turn-on level ON may be applied. The fourth transistor TR4 may be turned on in response to the second scan signal SCAN2 of the turn-on level ON. The first node N1 may be electrically connected to the second node N2.

A voltage of the first node N1 may be initialized as follows according to Formula 2.

$$VN 1 = VN 2 \qquad [ Formula 2 ]$$

In Formula 2, VN1 may be a voltage of the first node N1, and VN2 may be a voltage of the second node N2.

According to the value derived from Formula 1, VN1 which is the voltage of the first node N1 may be initialized to a value of VDD2_L+Vₜₕ_diode which is the same as the voltage of the second node N2.

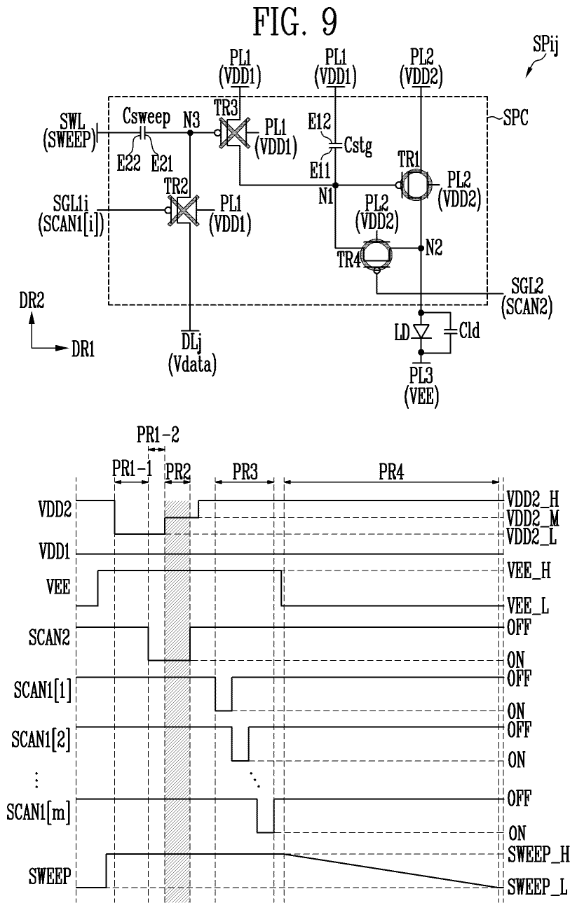

FIG. 9 is a schematic diagram illustrating the second period PR2 of FIG. 6.

Referring to FIG. 9, the second scan signal SCAN2 of the turn-on level may be applied in the second period PR2. A level of the second power voltage VDD2 may have the middle level VDD2_M.

The middle level VDD2_M of the second power voltage VDD2 may be set to a value within a range satisfying the following Formula 3.

$$VDD2\_M > VDD2\_L + {V}_{th} \_diode + \vert {V}_{th} \_TR1 \vert \qquad [ Formula 3 ]$$

In Formula 3, VDD2_M may be the second power voltage VDD2 of the middle level, VDD2_L+Vₜₕ_diode may be a voltage applied to the gate electrode of the first transistor TR1, and correspond to the voltage of the first node N1 in the previous (1-2)-th period PR1-2, and |Vₜₕ_TR1| may be an absolute value of the threshold voltage of the first transistor TR1. In an embodiment in which the first transistor TR1 includes a P-type semiconductor, the threshold voltage of the first transistor TR1 may have a negative value. In a range in which the middle level VDD2_M of the second power voltage VDD2 satisfies the above Formula 3, the first transistor TR1 may be turned on and the first node N1 and the second node N2 may be connected in a diode form.

In case that the first node N1 and the second node N2 are connected in a diode form in the second period PR2, the voltage of the first node N1 may be as the following Formula 4.

$$VN 1 = VDD2\_M - \vert {V}_{th} \_TR1 \vert \qquad [ Formula 4 ]$$

In the above Formula 4, VN1 may be a voltage of the first node N1, and VDD2_M may be a voltage applied to the source electrode of the first transistor TR1 and indicate the level of the second power voltage VDD2. In the second period PR2, the second power voltage VDD2 may have the middle level VDD2_M. |Vₜₕ_TR1| may be the absolute value of the threshold voltage of the first transistor TR1. Accordingly, a voltage in which the threshold voltage of the first transistor TR1 is reflected may be applied to the first node N1.

Threshold voltage fluctuation of the first transistor TR1 may be compensated in the second period PR2.

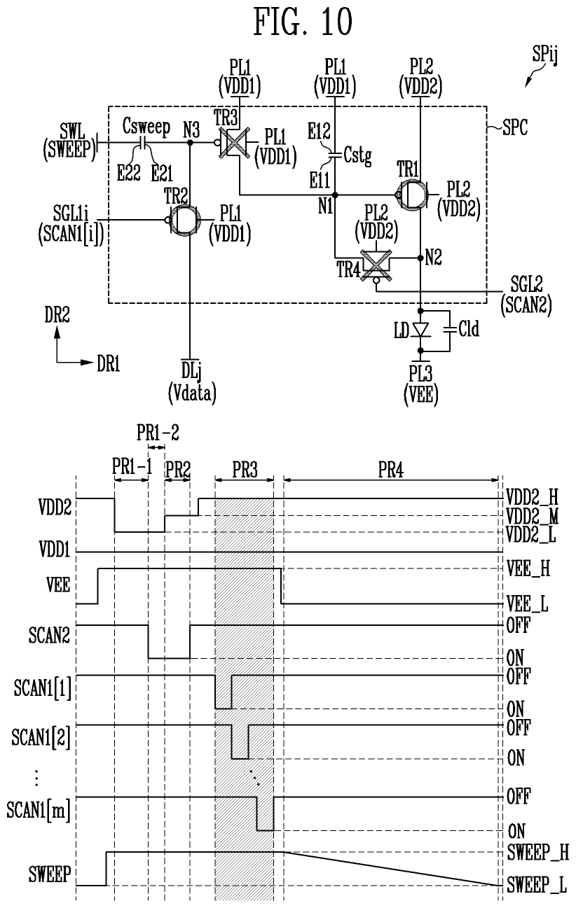

FIG. 10 is a schematic diagram illustrating the third period PR3 of FIG. 6.

Referring to FIG. 10, in the third period PR3, the first scan signal SCAN1[i] of the turn-on level may be supplied to the first sub-scan line SGL1i. For example, a turn-on level of the first scan signals SCAN1[1], SCAN1[2], . . . , and SCAN1[m] may be sequentially supplied from a first pixel row to an m-th pixel row.

The data voltage Vdata input at a timing that the first scan signal SCAN1[i] of the turn-on level is supplied may be applied to the third node N3.

The second capacitor Csweep may be charged with a charge corresponding to a difference between the sweep signal SWEEP of the high level SWEEP_H and the data voltage Vdata.

Accordingly, the data voltage Vdata may be written in the third period PR3.

In the third period PR3, the second power voltage VDD2 may have the high level VDD2_H.

In the third period PR3, the first transistor TR1 may be turned on, and thus the second power voltage VDD2 may be applied to the second node N2.

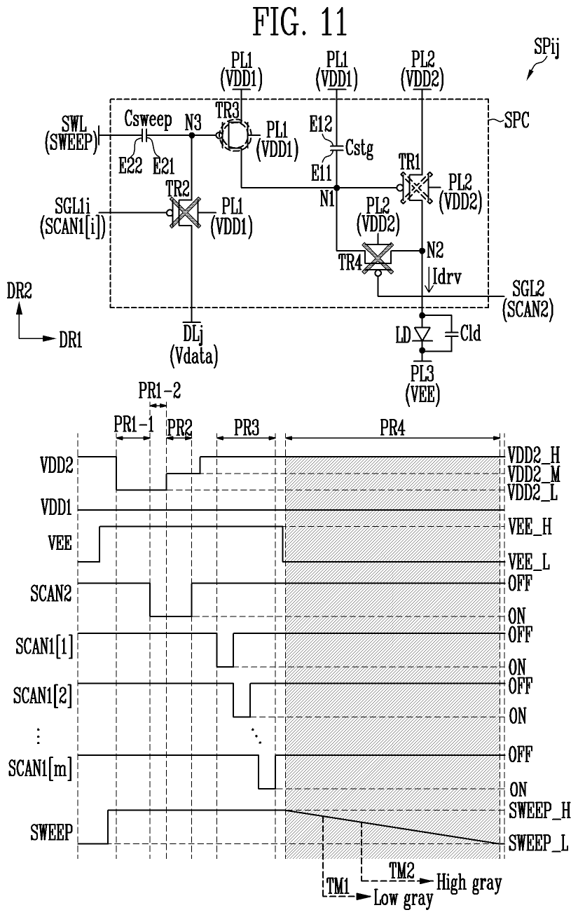

FIG. 11 is a schematic diagram illustrating the fourth period PR4 of FIG. 6.

In the fourth period PR4, the third power voltage VEE may be lowered to the low level VEE_L, and the driving current Idrv may flow through the first transistor TR1.

In case that the first transistor TR1 operates in a saturation area, a driving current Idrv may be calculated as the following Formula 5.

$$Idrv = \frac{1}{2} \times μ \times {C}_{ox} \times \frac{W}{L} \times {( \vert {V}_{gs} \vert - \vert {V}_{th} \_TR1 \vert )}^{2} \qquad [ Formula 5 ]$$

In the above Formula 5, Idrv may be a driving current, u may be a mobility of the first transistor TR1, Cox may be a gate capacitance per unit area of the first transistor TR1, L may be a length of a channel of the first transistor TR1, and W may be a width of the channel of the first transistor TR1.

When calculating |V_{gs}|−|Vₜₕ_TR1|, since |V_{gs}|−|Vₜₕ_TR1| is equal to |VDD2_M−|Vₜₕ_TR1|−VDD2_H|−|Vₜₕ_TR1|, and VDD2_H is greater than VDD2_M, |V_{gs}|−|Vₜₕ_TR1| may be calculated as “(VDD2_H−VDD2_M)+|Vₜₕ_TR1|−|Vₜₕ_TR1|”. When calculating this, a term indicated by |Vₜₕ_TR1| may be canceled, and thus the threshold voltage change of the first transistor TR1 may be compensated. The size of the driving current Idrv flowing through the first transistor TR1 may be controlled to be constant by adjusting a voltage difference between the high level VDD2_H and the middle level VDD2_M of the second power voltage VDD2.

Referring to FIG. 11, in the fourth period PR4, the level of the sweep signal SWEEP may gradually decrease from the high level SWEEP_H to a low level SWEEP_L. Since the second capacitor Csweep maintains a potential difference between the first electrode E21 and the second electrode E22, the voltage of the third node N3 may gradually decrease while having a waveform similar to the sweep signal SWEEP. In case that the voltage of the third node N3 becomes lower than the turn-on level of the third transistor TR3, the third transistor TR3 may be turned on, and the first power voltage VDD1 may be applied to the first node N1.

In case that the first power voltage VDD1 is applied to the first node N1, the first transistor TR1 may be turned off, and the driving current Idrv may not flow to the first transistor TR1. A timing when the driving current Idrv does not flow may be controlled according to the data voltage Vdata applied to the third node N3.

According to the timing when the driving current Idrv does not flow to the first transistor TR1, the light emitting element LD may display a high grayscale of image or a low grayscale of image. For example, a first time point TM1 and a second time point TM2 in case that the first transistor TR1 is turned off during the fourth period PR4 may be described as in FIG. 11. The first time point TM1 may be prior to the second time point TM2.

In case that the first transistor TR1 is turned off at the first time point TM1, the light emitting element LD may emit light with a relatively short time, and thus display lower grayscale of image. In case that the first transistor TR1 is turned off at the second time point TM2, the light emitting element LD may emit light with a relatively long time, and thus display higher grayscale of image.

Accordingly, embodiments of the disclosure may display images of different grayscales by controlling a duration of time in which the driving current Idrv flows through the light emitting element LD while maintaining the driving current Idrv flowing through the light emitting element LD to be constant. Accordingly, since a current flowing through the light emitting element LD is controlled constant, a change of a light emitting wavelength band due to a change of the current may be controlled. Accordingly, display quality may be improved.

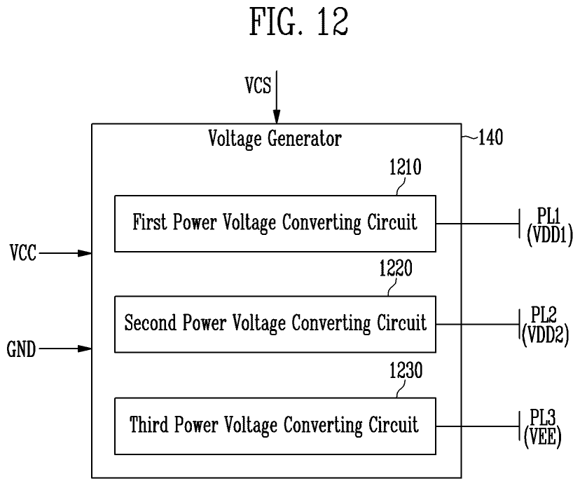

FIG. 12 is a schematic system block diagram schematically illustrating a voltage generator 140 according to embodiments of the disclosure.

Referring to FIG. 12, the voltage generator 140 according to embodiments of the disclosure may include a first power voltage converting circuit 1210, a second power voltage converting circuit 1220, a third power voltage converting circuit 1230, and the like.

The voltage generator 140 may receive a driving voltage VCC and a ground voltage GND. The voltage generator 140 may be configured to change a voltage to a voltage level between the driving voltage VCC and the ground voltage GND, based on the driving voltage VCC and the ground voltage GND. The voltage generator 140 may include, for example, a low drop-out (LDO) circuit, a DC-DC converter, and/or the like.

The first power voltage converting circuit 1210 may output the first power voltage VDD1 having a voltage level based on the driving voltage VCC and the ground voltage GND.

The second power voltage converting circuit 1220 may be configured to change the level of the second power voltage VDD2. The second power voltage converting circuit 1220 may receive the driving voltage VCC and the ground voltage GND and output the second power voltage VDD2 having a voltage level based on the voltage control signal VCS. For example, referring to FIG. 6, the second power voltage converting circuit 1220 may output the level of the second power voltage VDD2 as at least one of the high level VDD2_H, the middle level VDD2_M, and the low level VDD2_L based on the voltage control signal VCS.

The third power voltage converting circuit 1230 may be configured to change a level of the third power voltage VEE. The third power voltage converting circuit 1230 may receive the driving voltage VCC and the ground voltage GND, and output the third power voltage VEE having a voltage level based on the voltage control signal VCS. For example, referring to FIG. 6, the third power voltage converting circuit 1230 may output the level of the third power voltage VEE as at least one of the high level VEE_H and the low level VEE_L based on the voltage control signal VCS.

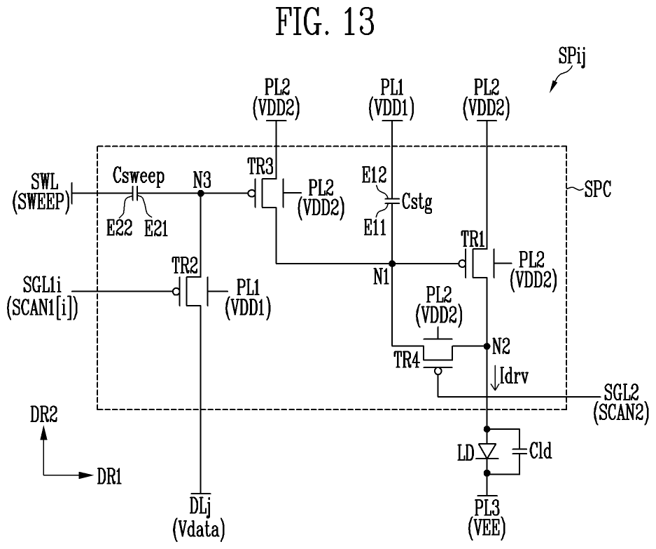

FIG. 13 is a schematic diagram of an equivalent circuit of a sub-pixel SPij according to embodiments of the disclosure.

Compared to the embodiment shown in FIG. 5, the sub-pixel SPij in FIG. 13 may have different configuration of the third transistor TR3, and remaining configurations may be configured similarly to the embodiment of FIG. 5.

Referring to FIG. 13, the third transistor TR3 may be configured to switch an electrical connection between the second power line PL2 and the first node N1. The third transistor TR3 may include a body electrode connected to the second power line PL2.

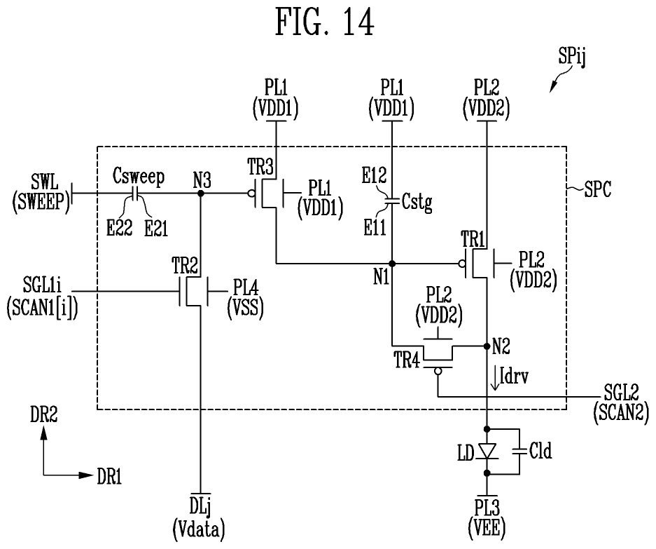

FIG. 14 is a schematic diagram of an equivalent circuit of a sub-pixel SPij according to embodiments of the disclosure.

Compared to the embodiment shown in FIG. 5, the sub-pixel SPij in FIG. 14 may have different configuration of the second transistor TR2, and remaining configurations may be configured similarly to the embodiment of FIG. 5.

Referring to FIG. 14, the second transistor TR2 may include a body electrode connected to the fourth power line PL4. A fourth power voltage VSS may be applied to the fourth power line PL4. For example, the fourth power voltage VSS may be a ground voltage. For example, a voltage level of the fourth power voltage VSS may be equal to the low level VEE_L (refer to FIG. 6) of the third power voltage VEE. However, embodiments of the disclosure are not limited thereto.

The second transistor TR2 may be implemented as a transistor including an N-type semiconductor. In an embodiment, the second transistor TR2 may be implemented as an NMOS.

In an embodiment, the voltage generator 140 (refer to FIG. 12) according to embodiments of the disclosure may further include a voltage converting circuit for generating the fourth power voltage VSS.

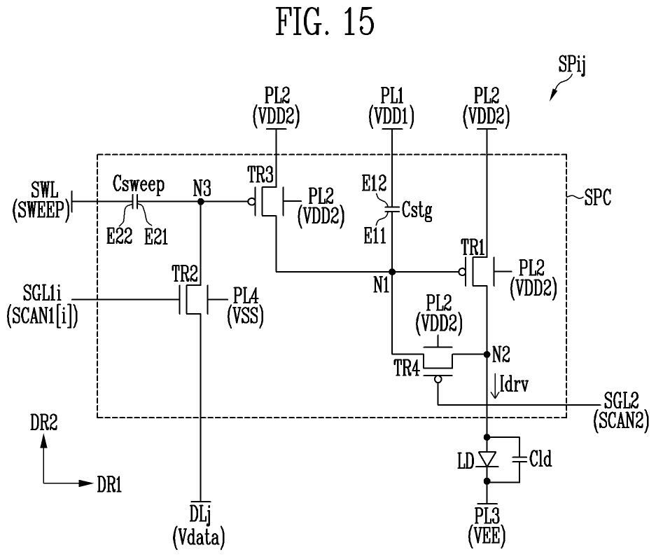

FIG. 15 is a schematic diagram of an equivalent circuit of a sub-pixel SPij according to embodiments of the disclosure.

Compared to the embodiment shown in FIG. 14, the sub-pixel SPij in FIG. 15 may have different configuration of the third transistor TR3, and remaining configurations may be configured similarly to the embodiment of FIG. 14.

Referring to FIG. 15, the third transistor TR3 may be configured to switch an electrical connection between the second power line PL2 and the first node N1. The third transistor TR3 may include a body electrode connected to the second power line PL2.

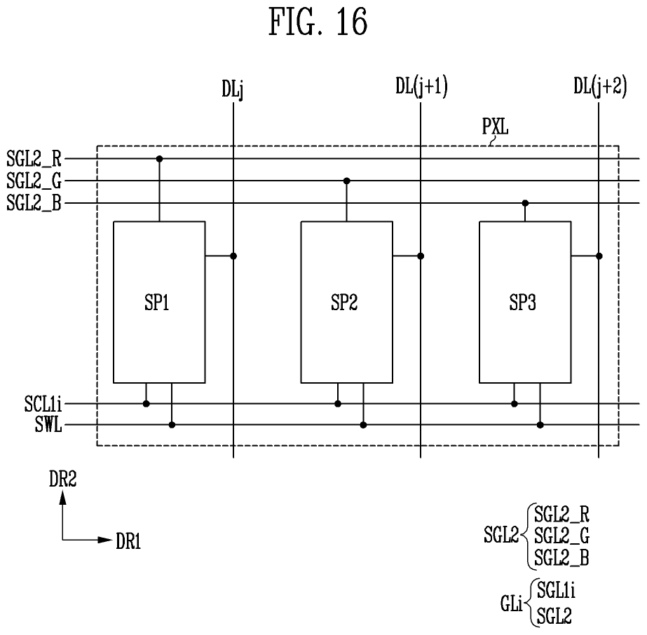

FIG. 16 is a schematic diagram of a pixel PXL according to embodiments of the disclosure.

Referring to FIG. 16, the pixel PXL according to embodiments of the disclosure may include the first to third sub-pixels SP1 to SP3. For convenience of description, a scan line GLi and the sweep line SWL connected to the pixel PXL are shown according to an embodiment.

The first sub-pixel SP1 may be connected to a first sub-scan line SGL1i, a (2_R)-th sub-scan line SGL2_R, a j-th data line DLj, and the sweep line SWL. The second sub-pixel SP2 may be connected to the first sub-scan line SGL1i, a (2_G)-th sub-scan line SGL2_G, a (j+1)-th data line DL (j+1), and the sweep line SWL. The third sub-pixel SP3 may be connected to the first sub-scan line SGL1i, a (2_B)-th sub-scan line SGL2_B, a (j+2)-th data line DL (j+2), and the sweep line SWL.

In an embodiment, the first sub-pixel SP1 may be a sub-pixel for emitting light of a first wavelength band (for example, a red wavelength band). The second sub-pixel SP2 may be a sub-pixel for emitting light of a second wavelength band (for example, a green wavelength band). The third sub-pixel SP3 may be a sub-pixel for emitting light of a third wavelength band (for example, a blue wavelength band).

In an embodiment, the first sub-pixel SP1 may be a red sub-pixel. The second sub-pixel SP2 may be a green sub-pixel. The third sub-pixel SP3 may be a blue sub-pixel. However, embodiments of the disclosure are not limited thereto. For convenience of description, an embodiment that the first to third sub-pixels SP1 to SP3 are the red sub-pixel, the green sub-pixel, and the blue sub-pixel, respectively, will be described.

The (2_R)-th sub-scan line SGL2_R, the (2_G)-th sub-scan line SGL2_G, and the (2_B)-th sub-scan line SGL2_B may configure the second sub-scan line SGL2. The second sub-scan line SGL2 may be commonly connected to multiple pixel rows.

A (2_R)-th scan signal may be supplied to the (2_R)-th sub-scan line SGL2_R. A (2_G)-th scan signal may be supplied to the (2_G)-th sub-scan line SGL2_G. A (2_B)-th scan signal may be supplied to the (2_B)-th sub-scan line SGL2_B.

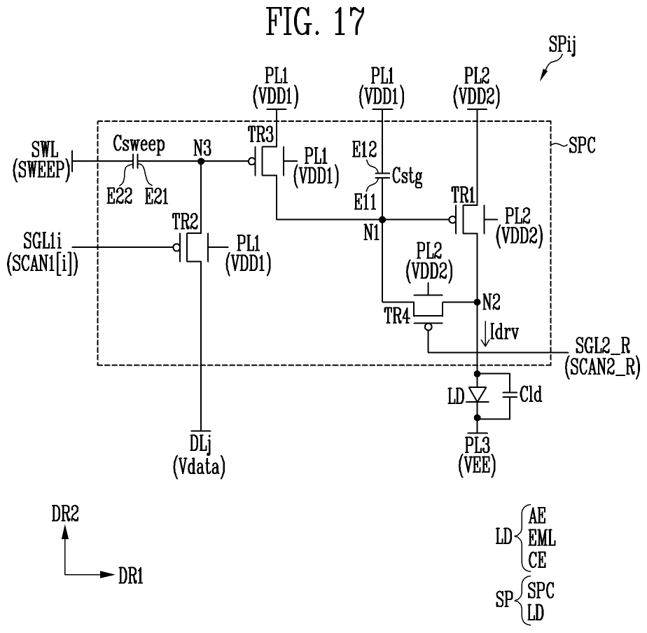

FIG. 17 is a schematic diagram of an equivalent circuit of a sub-pixel SPij according to embodiments of the disclosure.

Compared to the embodiment of FIG. 5, in embodiments of the disclosure, the gate electrode of the fourth transistor TR4 may be connected to the (2_R)-th sub-scan line SGL2_R. Remaining configurations may be configured similarly to the embodiment of FIG. 5.

Referring further to FIG. 16, even though the second sub-scan lines SGL2_R, SGL2_G, and SGL2_B connected to the fourth transistor TR4 are included in a same pixel PXL, the second sub-scan lines SGL2_R, SGL2_G, and SGL2_B connected to the fourth transistor TR4 may be different from each other according to a wavelength band of light emitted from the light emitting element LD.

The embodiment of FIG. 17 may be applied similarly to the sub-pixels SPij of FIGS. 13 to 15 described above. For example, the fourth transistor TR4 of each of the sub-pixels SPij of FIGS. 13 to 15 may be configured so that the gate electrode may be connected to the (2_R)-th sub-scan line SGL2_R.

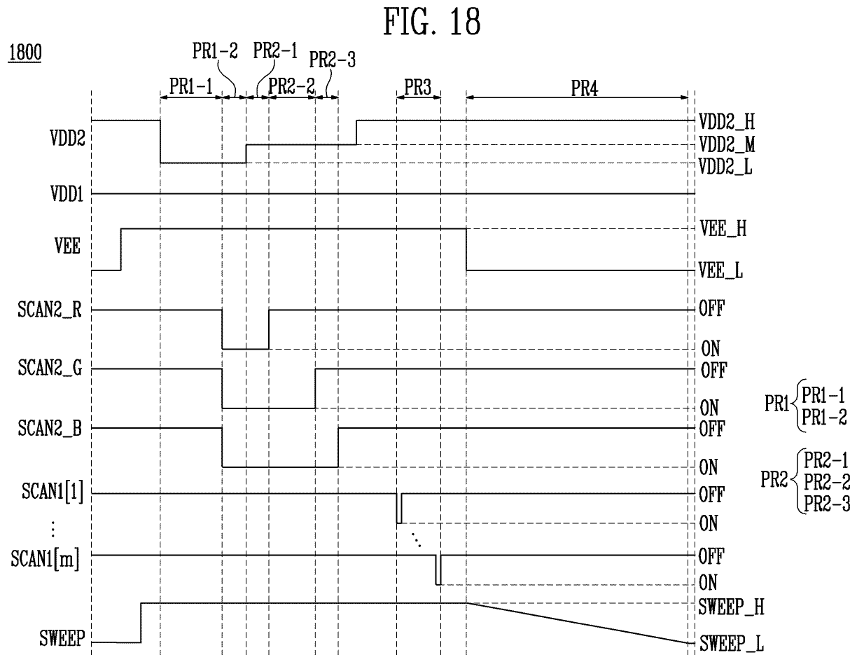

FIG. 18 is a schematic timing diagram illustrating a method 1800 of driving a display device according to embodiments of the disclosure.

Compared to the embodiment of FIG. 6, the method 1800 of driving the display device according to embodiments of the disclosure may include a second period PR2, and the second period PR2 may include a (2-1)-th period PR2-1, a (2-2)-th period PR2-2, and a (2-3)-th period PR2-3.

In the (1-1)-th period PR1-1, the second power voltage VDD2 may have the low level VDD2_L, the third power voltage VEE may have the high level VEE_H, the (2_R)-th scan signal SCAN2_R may have the turn-off level OFF, the (2_G)-th scan signal SCAN2_G may have the turn-off level OFF, the (2_B)-th scan signal SCAN2_B may have the turn-off level OFF, the first scan signals SCAN1[1] to SCAN1[m] may have the turn-off level OFF, and the sweep signal SWEEP may have the high level SWEEP_H.

In the (1-2)-th period PR1-2, the second power voltage VDD2 may have the low level VDD2_L, the third power voltage VEE may have the high level VEE_H, the (2_R)-th scan signal SCAN2_R may have the turn-on level ON, the (2_G)-th scan signal SCAN2_G may have the turn-on level ON, the (2_B)-th scan signal SCAN2_B may have the turn-on level ON, the first scan signals SCAN1[1] to SCAN1[m] may have the turn-off level OFF, and the sweep signal SWEEP may have the high level SWEEP_H.

In the (2-1)-th period PR2-1, the second power voltage VDD2 may have the middle level VDD2_M, the third power voltage VEE may have the high level VEE_H, the (2_R)-th scan signal SCAN2_R may have the turn-on level ON, the (2_G)-th scan signal SCAN2_G may have the turn-on level ON, the (2_B)-th scan signal SCAN2_B may have the turn-on level ON, the first scan signals SCAN1[1] to SCAN1[m] may have the turn-off level OFF, and the sweep signal SWEEP may have the high level SWEEP_H.

In the (2-2)-th period PR2-2, the second power voltage VDD2 may have the middle level VDD2_M, the third power voltage VEE may have the high level VEE_H, the (2_R)-th scan signal SCAN2_R may have the turn-off level OFF, the (2_G)-th scan signal SCAN2_G may have the turn-on level ON, the (2_B)-th scan signal SCAN2_B may have the turn-on level ON, the first scan signals SCAN1[1] to SCAN1[m] may have the turn-off level OFF, and the sweep signal SWEEP may have the high level SWEEP_H.

In the (2-3)-th period PR2-3, the second power voltage VDD2 may have the middle level VDD2_M, the third power voltage VEE may have the high level VEE_H, the (2_R)-th scan signal SCAN2_R may have the turn-off level OFF, the (2_G)-th scan signal SCAN2_G may have the turn-off level OFF, the (2_B)-th scan signal SCAN2_B may have the turn-on level ON, the first scan signals SCAN1[1] to SCAN1[m] may have the turn-off level OFF, and the sweep signal SWEEP may have the high level SWEEP_H.

In the third period PR3, the second power voltage VDD2 may have the high level VDD2_H, the third power voltage VEE may have the high level VEE_H, the (2_R)-th scan signal SCAN2_R may have the turn-off level OFF, the (2_G)-th scan signal SCAN2_G may have the turn-off level OFF, the (2_B)-th scan signal SCAN2_B may have the turn-off level OFF, the first scan signals SCAN1[1] to SCAN1[m] may sequentially have the turn-on level ON, and the sweep signal SWEEP may have the high level SWEEP_H.

In the fourth period PR4, the second power voltage VDD2 may have the high level VDD2_H, the third power voltage VEE may have the low level VEE_L, the (2_R)-th scan signal SCAN2_R may have the turn-off level OFF, the (2_G)-th scan signal SCAN2_G may have the turn-off level OFF, the (2_B)-th scan signal SCAN2_B may have the turn-off level OFF, the first scan signals SCAN1[1] to SCAN1[m] may have the turn-off level OFF, and the sweep signal SWEEP may gradually decrease from the high level SWEEP_H to the low level SWEEP_L.

In the method 1800 of driving the display device described above, the (2-1)-th period PR2-1 may be a period in which compensation is performed in the red sub-pixel, the green sub-pixel, and the blue sub-pixel. The (2-2)-th period PR2-2 may be a period in which compensation is performed in the green sub-pixel and the blue sub-pixel. The (2-3)-th period PR2-3 may be a period in which compensation is performed in the blue sub-pixel. Accordingly, compensation may be performed during a relatively longer time on a driving transistor of a color of which fluctuation of a threshold voltage is relatively larger. Accordingly, display quality may be improved.

In an embodiment, lengths of each of the (2-1)-th period PR2-1, the (2-2)-th period PR2-2, and the (2-3)-th period PR2-3 may be equal to each other. However, embodiments of the disclosure are not limited thereto, and in another embodiment, a length of one of the (2-1)-th period PR2-1, the (2-2)-th period PR2-2, and the (2-3)-th period PR2-3 may be different from a length of another ones of the (2-1)-th period PR2-1, the (2-2)-th period PR2-2, and the (2-3)-th period PR2-3.

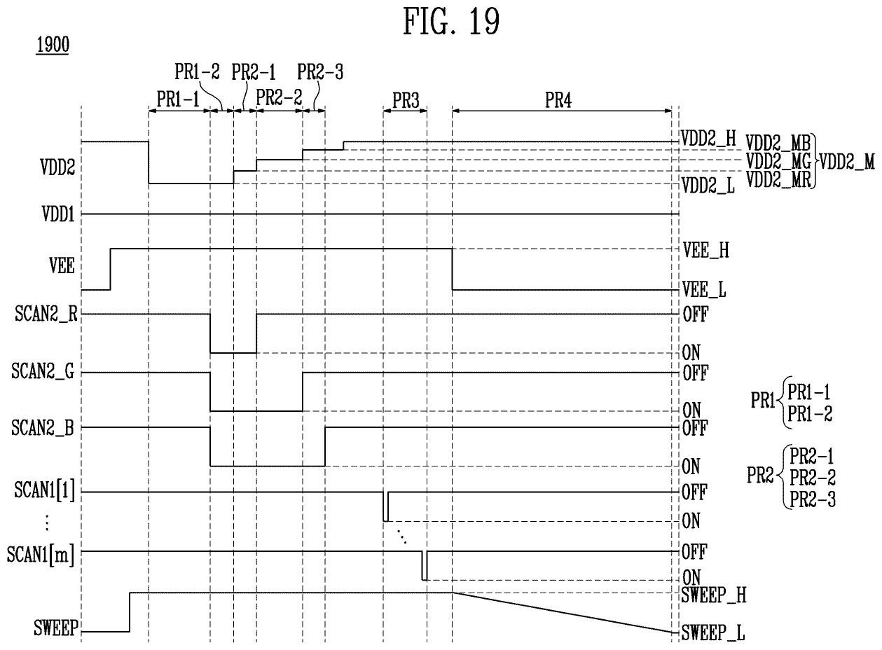

FIG. 19 is a schematic timing diagram illustrating a method 1900 of driving a display device according to embodiments of the disclosure.

Compared to the embodiment of FIG. 18, in the method 1900 of driving the display device according to embodiments of the disclosure, the second power voltage VDD2 may have a first middle level VDD2_MR, a second middle level VDD2_MG, and a third middle level VDD2_MB in the (2-1)-th period PR2-1, the (2-2)-th period PR2-2, and the (2-3)-th period PR2-3, respectively.

In the (1-1)-th period PR1-1, the second power voltage VDD2 may have the low level VDD2_L, the third power voltage VEE may have the high level VEE_H, the (2_R)-th scan signal SCAN2_R may have the turn-off level OFF, the (2_G)-th scan signal SCAN2_G may have the turn-off level OFF, the (2_B)-th scan signal SCAN2_B may have the turn-off level OFF, the first scan signals SCAN1[1] to SCAN1[m] may have the turn-off level OFF, and the sweep signal SWEEP may have the high level SWEEP_H.

In the (1-2)-th period PR1-2, the second power voltage VDD2 may have the low level VDD2_L, the third power voltage VEE may have the high level VEE_H, the (2_R)-th scan signal SCAN2_R may have the turn-on level ON, the (2_G)-th scan signal SCAN2_G may have the turn-on level ON, the (2_B)-th scan signal SCAN2_B may have the turn-on level ON, the first scan signals SCAN1[1] to SCAN1[m] may have the turn-off level OFF, and the sweep signal SWEEP may have the high level SWEEP_H.

In the (2-1)-th period PR2-1, the second power voltage VDD2 may have the first middle level VDD2_MR, the third power voltage VEE may have the high level VEE_H, the (2_R)-th scan signal SCAN2_R may have the turn-on level ON, the (2_G)-th scan signal SCAN2_G may have the turn-on level ON, the (2_B)-th scan signal SCAN2_B may have the turn-on level ON, the first scan signals SCAN1[1] to SCAN1[m] may have the turn-off level OFF, and the sweep signal SWEEP may have the high level SWEEP_H.

In the (2-2)-th period PR2-2, the second power voltage VDD2 may have the second middle level VDD2_MG, the third power voltage VEE may have the high level VEE_H, the (2_R)-th scan signal SCAN2_R may have the turn-off level OFF, the (2_G)-th scan signal SCAN2_G may have the turn-on level ON, the (2_B)-th scan signal SCAN2_B may have the turn-on level ON, the first scan signals SCAN1[1] to SCAN1[m] may have the turn-off level OFF, and the sweep signal SWEEP may have the high level SWEEP_H.

In the (2-3)-th period PR2-3, the second power voltage VDD2 may have the third middle level VDD2_MB, the third power voltage VEE may have the high level VEE_H, the (2_R)-th scan signal SCAN2_R may have the turn-off level OFF, the (2_G)-th scan signal SCAN2_G may have the turn-off level OFF, the (2_B)-th scan signal SCAN2_B may have the turn-on level ON, the first scan signals SCAN1[1] to SCAN1[m] may have the turn-off level OFF, and the sweep signal SWEEP may have the high level SWEEP_H.

In the third period PR3, the second power voltage VDD2 may have the high level VDD2_H, the third power voltage VEE may have the high level VEE_H, the (2_R)-th scan signal SCAN2_R may have the turn-off level OFF, the (2_G)-th scan signal SCAN2_G may have the turn-off level OFF, the (2_B)-th scan signal SCAN2_B may have the turn-off level OFF, the first scan signals SCAN1[1] to SCAN1[m] may sequentially have the turn-on level ON, and the sweep signal SWEEP may have the high level SWEEP_H.

In the fourth period PR4, the second power voltage VDD2 may have the high level VDD2_H, the third power voltage VEE may have the low level VEE_L, the (2_R)-th scan signal SCAN2_R may have the turn-off level OFF, the (2_G)-th scan signal SCAN2_G may have the turn-off level OFF, the (2_B)-th scan signal SCAN2_B may have the turn-off level OFF, the first scan signals SCAN1[1] to SCAN1[m] may have the turn-off level OFF, and the sweep signal SWEEP may gradually decrease from the high level SWEEP_H to the low level SWEEP_L.

In the method 1900 of driving the display device as described above, the (2-1)-th period PR2-1 may be a period in which compensation is performed in the red sub-pixel, the green sub-pixel, and the blue sub-pixel. The (2-2)-th period PR2-2 may be a period in which compensation is performed in the green sub-pixel and the blue sub-pixel. The (2-3)-th period PR2-3 may be a period in which compensation is performed in the blue sub-pixel. Accordingly, the driving current Idrv (refer to FIG. 17) may be different in the fourth period PR4, in each of the red sub-pixel, the green sub-pixel, and the blue sub-pixel. Accordingly, the driving current Idrv for emitting light from the corresponding light emitting element LD (refer to FIG. 17) may be set according to the wavelength band of the light emitted from the light emitting element LD. Therefore, light emitting efficiency of the light emitting element LD may be increased.

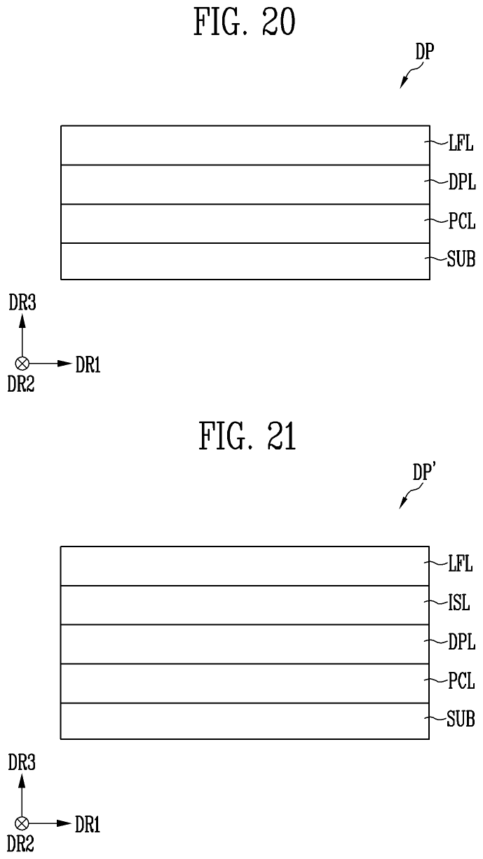

FIG. 20 is a schematic cross-sectional view illustrating an embodiment of the display panel DP of FIG. 2.

Referring to FIG. 20, the display panel DP may include a substrate SUB, and a pixel circuit layer PCL, a display element layer DPL, and a light functional layer LFL sequentially stacked on the substrate SUB in a third direction DR3 intersecting the first and second directions DR1 and DR2.

The substrate SUB may include a silicon wafer substrate formed using a semiconductor process. In another embodiment, the substrate SUB may be formed of an insulating material such as glass or a resin. For example, the substrate SUB may include a glass substrate. In another embodiment, the substrate SUB may include a polyimide (PI) substrate.

The pixel circuit layer PCL may be disposed on the substrate SUB. The pixel circuit layer PCL may include insulating layers and active patterns and conductive patterns disposed between the insulating layers. The conductive patterns of the pixel circuit layer PCL may form circuit elements, lines, and the like.

The circuit elements of the pixel circuit layer PCL may include the sub-pixel circuit SPC (refer to FIG. 3) of each of the sub-pixels SP of FIG. 2. For example, the circuit elements of the pixel circuit layer PCL may include the first to fourth transistors TR1 to TR4 and the first and second capacitors Cstg and Csweep as shown in FIG. 4 and the like.

The lines of the pixel circuit layer PCL may include lines connected to the sub-pixels SP of FIG. 2. The lines of the pixel circuit layer PCL may include the first to third power lines PL1 to PL3, the first and second sub-scan lines SGL1i and SGL2, the data lines DLj, the sweep line SWL, and the like shown in FIG. 4 and the like.

The display element layer DPL may be disposed on the pixel circuit layer PCL. The display element layer DPL may include a light emitting element of each of the sub-pixels SP.

The light functional layer LFL may be disposed on the display element layer DPL. The light functional layer LFL may include light conversion patterns having color conversion particles and/or scattering particles. For example, the color conversion particles may include quantum dots. The quantum dots may change a wavelength (or color) of light emitted from the display element layer DPL. The light functional layer LFL may further include light scattering patterns having scattering particles. In embodiments, the light conversion patterns and the light scattering patterns may be omitted.

The light functional layer LFL may further include a color filter layer including color filters. The color filter may selectively transmit light of a specific wavelength band (or a specific color). In embodiments, the color filter layer may be omitted.

A window (not illustrated) for protecting an exposure surface (or an upper surface) of the display panel DP may be provided on the light functional layer LFL. The window may be configured to protect the display panel DP from external shock. The window may be coupled to the light functional layer LFL by an optically transparent adhesive (or cohesive) member. The window may have a multi-layer structure including at least one of a glass substrate, a plastic film, and a plastic substrate. The multi-layer structure may be formed through a continuous process or an adhesion process using an adhesive layer. All or a portion of the window may be flexible.

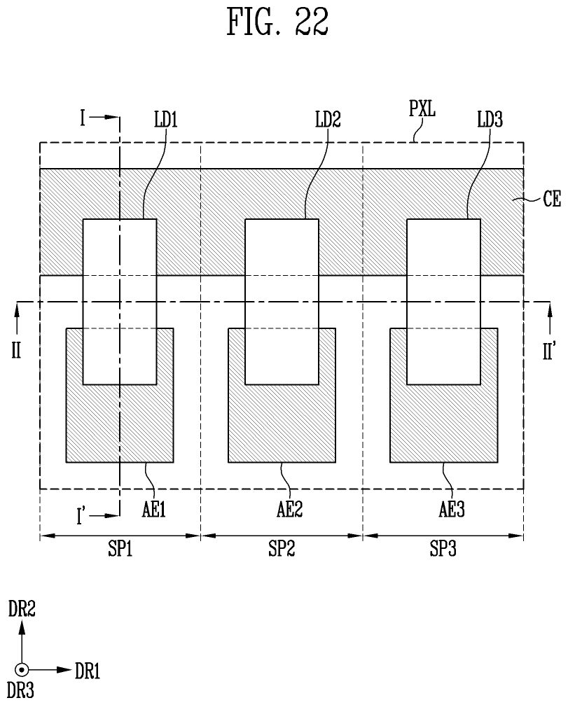

FIG. 21 is a schematic cross-sectional view illustrating another embodiment of the display panel DP′ of FIG. 2.

Referring to FIG. 21, the display panel DP′ may include the substrate SUB, the pixel circuit layer PCL, the display element layer DPL, an input sensing layer ISL, and the light functional layer LFL. The substrate SUB, the pixel circuit layer PCL, the display element layer DPL, and the light functional layer LFL may be configured similarly to the substrate SUB, the pixel circuit layer PCL, the display element layer DPL, and the light functional layer LFL described with reference to FIG. 20, respectively. Hereinafter, an overlapping description is omitted.

The input sensing layer ISL may sense a user input on an upper surface (or a display surface) of the display panel DP′. The input sensing layer ISL may include components suitable for sensing an external object such as a user's hand, or a pen. For example, the input sensing layer ISL may include touch electrodes.

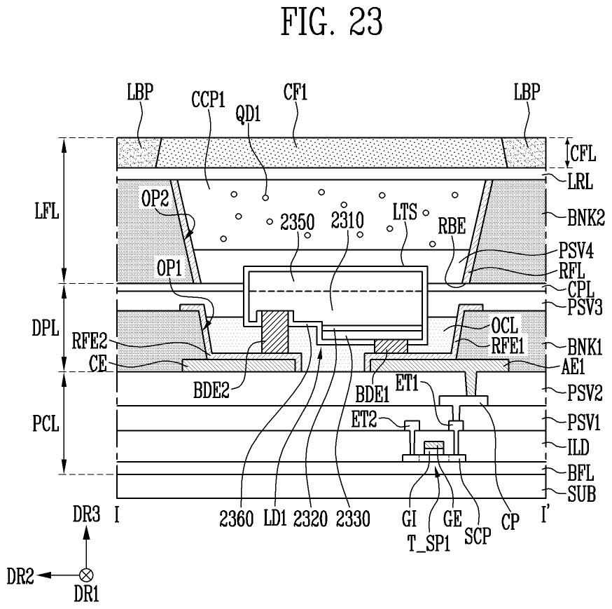

FIG. 22 is a plan view illustrating an embodiment of one of the pixels PXL of FIG. 2.

Referring to FIG. 22, the pixel PXL may include the first to third sub-pixels SP1 to SP3. The first to third sub-pixels SP1 to SP3 may be arranged in the first direction DR1. However, an arrangement of the pixel PXL is not limited thereto and may change according to embodiments. For example, the first to third sub-pixels SP1 to SP3 may be arranged in a zigzag.

First to third anode electrodes AE1 to AE3 may be disposed in the first to third sub-pixels SP1 to SP3, respectively. The first anode electrode AE1 may be provided as an electrode connected to the sub-pixel circuit SPC (refer to FIG. 3) of the first sub-pixel SP1. The second anode electrode AE2 may be provided as an electrode connected to the sub-pixel circuit SPC of the second sub-pixel SP2. The third anode electrode AE3 may be provided as an electrode connected to the sub-pixel circuit SPC of the third sub-pixel SP3.

The cathode electrode CE may be spaced apart from the first to third anode electrodes AE1 to AE3. The cathode electrode CE and the first to third anode electrodes AE1 to AE3 may be disposed at a same height. The cathode electrode CE may be spaced apart from the first to third anode electrodes AE1 to AE3 in the second direction DR2. In embodiments, the cathode electrode CE may extend in the first direction DR1 and may be used as a common electrode for the pixel PXL and other pixels adjacent to the pixel PXL. Although not shown, according to an embodiment, the cathode electrode CE may extend in the second direction DR2 as well as the first direction DR1 and may be used as a common electrode for all of the sub-pixels SP of FIG. 2. As described above, the cathode electrode CE may have various shapes.

First to third light emitting elements LD1 to LD3 may be disposed on the first to third anode electrodes AE1 to AE3 and the cathode electrode CE. The first light emitting element LD1 may be electrically connected to the first anode electrode AE1 and the cathode electrode CE. The first light emitting element LD1 may be provided as the light emitting element LD connected to the sub-pixel circuit SPC of the first sub-pixel SP1. The second light emitting element LD2 may be electrically connected to the second anode electrode AE2 and the cathode electrode CE. The second light emitting element LD2 may be provided as the light emitting element LD connected to the sub-pixel circuit SPC of the second sub-pixel SP2. The third light emitting element LD3 may be electrically connected to the third anode electrode AE3 and the cathode electrode CE. The third light emitting element LD3 may be provided as the light emitting element LD connected to the sub-pixel circuit SPC of the third sub-pixel SP3.

The first light emitting element LD1, the second light emitting element LD2, and the third light emitting element LD3 may be inorganic light emitting diodes including an inorganic light emitting material. However, embodiments of the disclosure are not limited thereto. For example, the first to third light emitting elements LD1 to LD3 may be organic light emitting diodes.

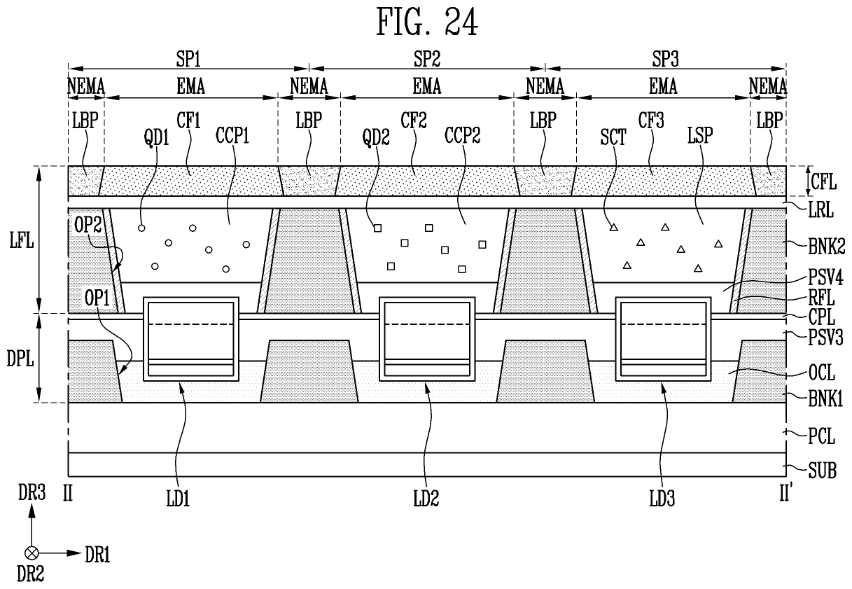

FIG. 23 is a schematic cross-sectional view taken along line I-I′ of FIG. 22.

Referring to FIGS. 22 and 23, the pixel circuit layer PCL, the display element layer DPL, and the light functional layer LFL may be sequentially disposed on the substrate SUB.

The pixel circuit layer PCL may include insulating layers, active pattern layers, and conductive patterns stacked on the substrate SUB. The insulating layers may include a buffer layer BFL, a gate insulating layer GI, one or more interlayer insulating layers ILD, and one or more via layers PSV1 and PSV2. The active pattern layers and the conductive patterns may be positioned between the insulating layers. The conductive patterns may include at least one of copper (Cu), molybdenum (Mo), tungsten (W), aluminum neodymium (AlNd), titanium (Ti), aluminum (Al), and silver (Ag).

As described with reference to FIG. 4, the sub-pixel circuit SPC may include one or more transistors and one or more capacitors. The active pattern layers and the conductive patterns of the pixel circuit layer PCL may form the transistors and the capacitors of the sub-pixel circuit SPC. The conductive patterns of the pixel circuit layer PCL may further form lines.

The buffer layer BFL may be disposed on a surface of the substrate SUB. The buffer layer BFL may prevent an impurity from diffusing into the circuit elements and the lines included in the pixel circuit layer PCL. The buffer layer BFL may include an inorganic insulating layer including an inorganic material. In embodiments, the buffer layer BFL may include at least one of silicon nitride (SiNₓ), silicon oxide (SiOₓ), silicon oxynitride (SiOₓN_{y}), and a metal oxide such as aluminum oxide (AlOₓ). The buffer layer BFL may be provided as a single layer or multiple layers. In case that the buffer layer BFL is provided as multiple layers, each layer may be formed of a same material or may be formed of different materials. In an embodiment, the buffer layer BFL may be omitted.

In embodiments, one or more barrier layers may be disposed between the substrate SUB and the buffer layer BFL. For example, each of the barrier layers may include polyimide.

A transistor T_SP1 may be disposed on the buffer layer BFL. The transistor T_SP1 may be one of the transistors included in the sub-pixel circuit SPC of the first sub-pixel SP1.

The transistor T_SP1 may include a semiconductor layer SCP, a gate electrode GE, a first terminal ET1, and a second terminal ET2. The first terminal ET1 may be one of a source electrode and a drain electrode, and the second terminal ET2 may be another one of the source electrode and the drain electrode. For example, the first terminal ET1 may be the source electrode, and the second terminal ET2 may be the drain electrode.

The semiconductor layer SCP may be disposed on the buffer layer BFL. The semiconductor layer SCP may include a first contact area connected to the first terminal ET1 and a second contact area connected to the second terminal ET2. An area between the first contact area and the second contact area may be a channel area. The channel area may overlap the gate electrode GE of the transistor T_SP1 in a plan view. The channel area may be a semiconductor pattern that is not doped with an impurity and may be an intrinsic semiconductor. The first contact area and the second contact area may be a semiconductor pattern doped with an impurity. As an impurity, for example, a p-type impurity may be used, but embodiments of the disclosure are not limited thereto.

The semiconductor layer SCP may include one of various types of semiconductors, for example, an amorphous silicon semiconductor, a monocrystalline silicon semiconductor, a polycrystalline silicon semiconductor, a low temperature poly silicon semiconductor, and an oxide semiconductor.

The interlayer insulating layers ILD sequentially stacked may be disposed on the semiconductor layer SCP. The interlayer insulating layers ILD may be inorganic insulating layers including an inorganic material. For example, each of the interlayer insulating layers ILD may include at least one of silicon nitride (SiNₓ), silicon oxide (SiOₓ), silicon oxynitride (SiOₓN_{y}), and a metal oxide such as aluminum oxide (AlOₓ). However, the interlayer insulating layers ILD are not limited thereto. For example, one of the interlayer insulating layers ILD may include an organic insulating layer including an organic material.

The interlayer insulating layers ILD may electrically separate conductive patterns and/or active pattern layers disposed between the interlayer insulating layers ILD from each other. For example, the interlayer insulating layers ILD may include a gate insulating layer GI disposed on the semiconductor layer SCP. The gate insulating layer GI may be disposed between the semiconductor layer SCP and the gate electrode GE so that the gate electrode GE is spaced apart from the semiconductor layer SCP. In embodiments, the gate insulating layer GI may be provided entirely on the semiconductor layer SCP and the buffer layer BFL to cover the semiconductor layer SCP and the buffer layer BFL. As the number of layers required for the conductive patterns and/or the semiconductor patterns increases, the number of interlayer insulating layers ILD may increase.

The gate electrode GE may be disposed on the gate insulating layer GI. The gate electrode GE may overlap the channel area of the semiconductor layer SCP in a plan view. In embodiments, the gate electrode GE may be provided as a single layer including at least one of copper (Cu), molybdenum (Mo), tungsten (W), aluminum neodymium (AlNd), titanium (Ti), aluminum (Al), and silver (Ag). In embodiments, the gate electrode GE may be provided as multiple layers including at least one of molybdenum (Mo), titanium (Ti), copper (Cu), aluminum (Al), and silver (Ag), which are low-resistance materials.

The first and second terminals ET1 and ET2 may be disposed on the interlayer insulating layers ILD. The first and second terminals ET1 and ET2 may be connected to the semiconductor layer SCP through contact holes passing through the interlayer insulating layers ILD. The first and second terminals ET1 and ET2 may be respectively connected to a source area and a drain area of the semiconductor layer SCP. Each of the first and second terminals ET1 and ET2 may include at least one of copper (Cu), molybdenum (Mo), tungsten (W), aluminum neodymium (AlNd), titanium (Ti), aluminum (Al), and silver (Ag).

In embodiments, the transistor T_SP1 may be configured as a transistor including a low-temperature polycrystalline silicon semiconductor. However, embodiments are not limited thereto. For example, the transistor T_SP1 may be configured as a transistor including an oxide semiconductor.

In FIG. 23, an embodiment that the transistor T_SP1 is a transistor of a top gate structure is described, but embodiments of the disclosure are not limited thereto. For example, the transistor T_SP1 may be a transistor of a bottom gate structure. A structure of the transistor T_SP1 may be variously changed.

At least some of the various lines of the display panel DP and/or the display device DD may be further disposed on the interlayer insulating layers ILD.

The first via layer PSV1 may be disposed on the first and second terminals ET1 and ET2. A via layer may be referred to as a protective layer. The first via layer PSV1 may be configured to protect components disposed under the first via layer PSV1 and provide a flat upper surface.

A connection pattern CP may be disposed on the first via layer PSV1. The connection pattern CP may be connected to the first terminal ET1 of the transistor T_SP1 by passing through the first via layer PSV1. The connection pattern CP may include at least one of copper (Cu), molybdenum (Mo), tungsten (W), aluminum neodymium (AlNd), titanium (Ti), aluminum (Al), and silver (Ag).

Referring to FIG. 1 further, at least some of various lines of the display panel DP and/or the display device DD may be further disposed on the first via layer PSV1.

The second via layer PSV2 may be disposed on the connection pattern CP and the first via layer PSV1. The second via layer PSV2 may be configured to protect components disposed under the second via layer PSV2 and provide a flat upper surface.

Each of the first and second via layers PSV1 and PSV2 may include an inorganic insulating layer including an inorganic material and/or an organic insulating layer including an organic material. The inorganic insulating layer may include, for example, at least one of silicon oxide (SiOₓ), silicon nitride (SiNₓ), silicon oxynitride (SiOₓN_{y}), and a metal oxide such as aluminum oxide (AlOₓ). The organic insulating layer may include, for example, at least one of an acrylic resin, an epoxy resin, a phenol resin, a polyamide resin, a polyimide resin, an unsaturated polyester resin, a poly-phenylene ether resin, a poly-phenylene sulfide resin, and a benzocyclobutene resin.

According to an embodiment, each of the first and second via layers PSV1 and PSV2 and one of the interlayer insulating layers ILD may include a same material. However, embodiments of the disclosure are not limited thereto. Each of the first and second via layers PSV1 and PSV2 may be provided as a single layer, or may be provided as multiple layers according to an embodiment.

The display element layer DPL may be disposed on the second via layer PSV2. The display element layer DPL may include the first anode electrode AE1, the cathode electrode CE, a first bank BNK1, first and second reflective electrodes RFE1 and RFE2, the first light emitting element LD1, an overcoat layer OCL, a third via layer PSV3, a capping layer CPL, and the like.

On the pixel circuit layer PCL, the first anode electrode AE1 and the cathode electrode CE may be disposed.

The first anode electrode AE1 may be electrically connected to the connection pattern CP through a contact hole passing through the second via layer PSV2. As described above, the first anode electrode AE1 may be electrically connected to the first transistor T_SP1.

The cathode electrode CE may be spaced apart from the first anode electrode AE1 in the second direction DR2. The cathode electrode CE may be electrically connected to the second power voltage node VEEN of FIG. 3. Accordingly, the third power voltage VEE (refer to FIG. 4) applied to the second power voltage node VEEN may be transmitted to the cathode electrode CE.

The first bank BNK1 may be disposed on the first anode electrode AE1 and the cathode electrode CE. The first bank BNK1 may include a first opening OP1 exposing at least a portion of the first anode electrode AE1 and the cathode electrode CE. The first light emitting element LD1 may be disposed in the first opening OP1 of the first bank BNK1. As described above, the first bank BNK1 may be provided as a pixel defining layer defining an area where the first light emitting element LD1 is positioned.

The first bank BNK1 may include a light blocking material to prevent light mixing between adjacent sub-pixels. In embodiments, the first bank BNK1 may include an organic material. For example, the first bank BNK1 may include an organic insulating material such as an acryl resin, an epoxy resin, a phenol resin, a polyamide resin, and a polyimide resin.

The first reflective electrode RFE1 may be disposed on an exposed portion of the first anode electrode AE1 and on a side surface of the first bank BNK1 adjacent to the exposed portion of the first anode electrode AE1. The second reflective electrode RFE2 may be disposed on an exposed portion of the cathode electrode CE and on a side surface of the first bank BNK1 adjacent to the exposed portion of the cathode electrode CE. The first and second reflective electrodes RFE1 and RFE2 may include a conductive material suitable for reflecting light. Accordingly, light output efficiency of the first light emitting element LD1 may be improved. In embodiments, the first and second reflective electrodes RFE1 and RFE2 may include at least one of aluminum (Al), silver (Ag), magnesium (Mg), platinum (Pt), palladium (Pd), gold (Au), nickel (Ni), neodymium (Nd), iridium (Ir), chromium (Cr), titanium (Ti), and an alloy thereof. However, embodiments are not limited thereto.

The first light emitting element LD1 may be electrically connected to the first anode electrode AE1 through the first reflective electrode RFE1. The first light emitting element LD1 may be electrically connected to the cathode electrode CE through the second reflective electrode RFE2. The first light emitting element LD1 may be bonded and coupled to the first and second reflective electrodes RFE1 and RFE2.

The first light emitting element LD1 may include a first semiconductor layer 2310, an active layer 2320, a second semiconductor layer 2330, and an auxiliary layer 2350. The first light emitting element LD1 may include a light emitting stack in which the auxiliary layer 2350, the first semiconductor layer 2310, the active layer 2320, and the second semiconductor layer 2330 are sequentially stacked.

The first light emitting element LD1 may include first and second bonding electrodes BDE1 and BDE2 facing a same direction (for example, in a direction opposite to the third direction DR3). The first bonding electrode BDE1 may be connected to the second semiconductor layer 2330. The second bonding electrode BDE2 may be connected to the first semiconductor layer 2310 exposed by etching the second semiconductor layer 2330 and the active layer 2320. The first light emitting element LD1 may be a flip chip type light emitting element.

The first semiconductor layer 2310 may be configured to provide an electron to the active layer 2320. The first semiconductor layer 2310 may include, for example, at least one n-type semiconductor layer. For example, the first semiconductor layer 2310 may include at least one of gallium nitride (GaN), aluminum gallium nitride (AlGaN), indium gallium nitride (InGaN), aluminum nitride (AlN), and indium nitride (InN), and may be an n-type semiconductor layer doped with a first conductive dopant (or an n-type dopant) such as silicon (Si), germanium (Ge), or tin (Sn). However, a material configuring the first semiconductor layer 2310 is not limited thereto, and various other materials may configure the first semiconductor layer 2310. In an embodiment, the first semiconductor layer 2310 may include a gallium nitride (GaN) semiconductor material doped with the first conductive dopant (or the n-type dopant). According to an embodiment, the first semiconductor layer 2310 may form an n-type semiconductor layer together with the auxiliary layer 2350.

The active layer 2320 may be disposed on the first semiconductor layer 2310 and may be an area where an electron and a hole recombine. As the electron and the hole recombine in the active layer 2320, the electron and the hole may transit to a lower energy level, and light having a wavelength corresponding to the transition may be generated. The active layer 2320 may be formed as a single or multiple quantum well structure. In an embodiment in which the active layer 2320 is formed as a multiple quantum well structure, a unit including a barrier layer, a strain reinforcing layer, and a well layer may be repeatedly stacked each other to configure the active layer 2320. However, embodiments of the active layer 2320 are not limited to that described above.

The second semiconductor layer 2330 may be disposed on the active layer 2320 and may provide a hole to the active layer 2320. The second semiconductor layer 2330 may include a semiconductor layer of a type different from the first semiconductor layer 2310. For example, the second semiconductor layer 2330 may include at least one p-type semiconductor layer. For example, the second semiconductor layer 2330 may include at least one of gallium nitride (GaN), aluminum gallium nitride (AlGaN), indium gallium nitride (InGaN), aluminum nitride (AlN), and indium nitride (InN), and may be a p-type semiconductor layer doped with a second conductive dopant (or a p-type dopant), such as magnesium (Mg), zinc (Zn), calcium (Ca), strontium (Sr), and barium (Ba). However, a material configuring the second semiconductor layer 2330 is not limited thereto, and various other materials may configure the second semiconductor layer 2330. In an embodiment of the disclosure, the second semiconductor layer 2330 may include a gallium nitride (GaN) semiconductor material doped with the second conductive dopant (or the p-type dopant).

The auxiliary layer 2350 may include a gallium nitride (GaN) semiconductor material that is not doped with an impurity, and may configure an n-type semiconductor layer together with the first semiconductor layer 2310.

The first bonding electrode BDE1 may be electrically connected to the second semiconductor layer 2330. The second bonding electrode BDE2 may be electrically connected to the first semiconductor layer 2310. The first and second bonding electrodes BDE1 and BDE2 may include a eutectic metal.

The first light emitting element LD1 may further include an insulating layer 2360 configured to cover an outer surface of the light emitting stack. The insulating layer 2360 may be configured to prevent an electrical short circuit that may occur in case that the active layer 2320 contacts a conductive material other than the first and second semiconductor layers 2310 and 2330. The insulating layer 2360 may include a transparent insulating material. The insulating layer 2360 may be configured to expose lower surfaces of the first and second bonding electrodes BDE1 and BDE2.

A lower surface of the first bonding electrode BDE1 may be connected to the first reflective electrode RFE1. Accordingly, the first bonding electrode BDE1 may be electrically connected to the first anode electrode AE1 through the first reflective electrode RFE1. A lower surface of the second bonding electrode BDE2 may be connected to the second reflective electrode RFE2. Accordingly, the second bonding electrode BDE2 may be electrically connected to the cathode electrode CE through the second reflective electrode RFE2.

The overcoat layer OCL may be disposed in the first opening OP1 in which the first and second reflective electrodes RFE1 and RFE2 and the first light emitting element LD1 are disposed. The overcoat layer OCL may be configured to fix the first light emitting element LD1 to the first and second reflective electrodes RFE1 and RFE2. The overcoat layer OCL may protect configurations disposed under the overcoat layer OCL from a foreign substance such as dust and moisture. For example, the overcoat layer OCL may include at least one of an inorganic insulating layer and an organic insulating layer. For example, the overcoat layer OCL may include an epoxy resin, but embodiments of the disclosure are not limited thereto.

The third via layer PSV3 may be disposed on the first bank BNK1 and the overcoat layer OCL. The third via layer PSV3 may protect components disposed under the third via layer PSV3 and may provide a flat upper surface. The third via layer PSV3 and one of the first and second via layers PSV1 and PSV2 may include a same material. However, embodiments of the disclosure are not limited thereto.

In embodiments, the third via layer PSV3 may not be disposed on an upper surface LTS of the first light emitting element LD1. The first light emitting element LD1 may protrude to the light functional layer LFL. The first light emitting element LD1 may be at least partially positioned in a second opening OP2 of a second bank BNK2. For example, the upper surface LTS of the first light emitting element LD1 from the substrate SUB may be higher than the lowermost end RBE of a reflective layer RFL. Accordingly, light emitted from the first light emitting element LD1 may be provided to the light function layer LFL at a relatively high rate.

The capping layer CPL may be disposed on the third via layer PSV3. The capping layer CPL may protect components under the capping layer CPL, such as the first light emitting element LD1, from external moisture, humidity, and the like. In embodiments, the capping layer CPL may not be disposed on the upper surface of the first light emitting element LD1. In other embodiments, the capping layer CPL may entirely cover the first light emitting element LD1 and the third via layer PSV3. The capping layer CPL may include at least one of silicon nitride (SiNₓ), silicon oxide (SiOₓ), silicon oxynitride (SiOₓN_{y}), and a metal oxide such as aluminum oxide (AlOₓ). However, embodiments of the capping layer CPL are not limited to that described above.

The pixel circuit layer PCL and the display element layer DPL of the first sub-pixel SP1 are described above. Each of the second and third sub-pixels SP2 and SP3 of FIG. 22 may be configured similarly to the first sub-pixel SP1 to the extent that is not otherwise described herein.

The light function layer LFL may be disposed on the capping layer CPL. The light function layer LFL may include the second bank BNK2, the reflective layer RFL, a fourth via layer PSV4, a first light conversion pattern CCP1, a low refractive layer LRL, a color filter layer CFL, and the like.

The second bank BNK2 may be disposed on the capping layer CPL. The second bank BNK2 may overlap the first bank BNK1 in a plan view. The second bank BNK2 may have the second openings OP2 overlapping the first openings OP1 in a plan view.

The second bank BNK2 may include a light blocking material to prevent light mixing between adjacent sub-pixels. In embodiments, the second bank BNK2 may include an organic material. For example, the second bank BNK2 may include an organic insulating material such as an acryl resin, an epoxy resin, a phenol resin, a polyamide resin, and a polyimide resin.

The reflective layer RFL may be disposed on side surfaces of the second bank BNK2 in the second openings OP2. The reflective layer RFL may be configured to reflect incident light, and thus light output efficiency may be improved. The reflective layer RFL may include a material suitable for reflecting light. The reflective layer RFL may include at least one of aluminum (Al), silver (Ag), magnesium (Mg), platinum (Pt), palladium (Pd), gold (Au), nickel (Ni), neodymium (Nd), iridium (Ir), chromium (Cr), titanium (Ti), and an alloy thereof. However, embodiments are not limited thereto.

On the capping layer CPL, the fourth via layer PSV4 may be disposed in the second opening OP2. The fourth via layer PSV4 may protect components disposed under the fourth via layer PSV4 and provide a flat upper surface. The fourth via layer PSV4 and one of the first to third via layers PSV1 to PSV3 may include a same material. However, embodiments of the disclosure are not limited thereto.

On the fourth via layer PSV4, the first light conversion pattern CCP1 may be disposed in the second opening OP2.

The first light conversion pattern CCP1 may include color conversion particles and/or scattering particles. The color conversion particles may change a wavelength of incident light and convert the incident light into light of another color. The color conversion particles may scatter the incident light. In embodiments, the color conversion particles may be quantum dots. The scattering particles may scatter the incident light.

The first sub-pixel SP1 may be a red sub-pixel. In case that the first light emitting element LD1 emits light of a blue color, the first light conversion pattern CCP1 may include first color conversion particles QD1 configured to convert light of the blue color into light of a red color. In case that the first light emitting element LD1 emits light of a red color, the first light conversion pattern CCP1 may include scattering particles. As described above, particles included in the first light conversion pattern CCP1 may be variously changed according to the first light emitting element LD1.

The low refractive layer LRL may be disposed on the second bank BNK2, the reflective layer RFL, and the first light conversion pattern CCP1. The low refractive layer LRL may have a refractive index lower than a refractive index of the first light conversion pattern CCP1. The low refractive layer LRL may be configured to refract or totally reflect corresponding light according to an incident angle of the light. For example, the low refractive layer LRL may provide light passing through the first light conversion pattern CCP1 back to the first light conversion pattern CCP1. Accordingly, light conversion efficiency of the first light conversion pattern CCP1 may be improved.

The color filter layer CFL may be disposed on the low refractive layer LRL. The color filter layer CFL may include a first color filter CF1 and light blocking patterns LBP. The first color filter CF1 overlaps the first light conversion pattern CCP1 in a plan view. The first color filter CF1 may selectively transmit light of a desired wavelength range. In case that the first sub-pixel SP1 is a red sub-pixel, the first color filter CF1 may be a red color filter. The light blocking patterns LBP may include at least one of various types of light blocking materials.

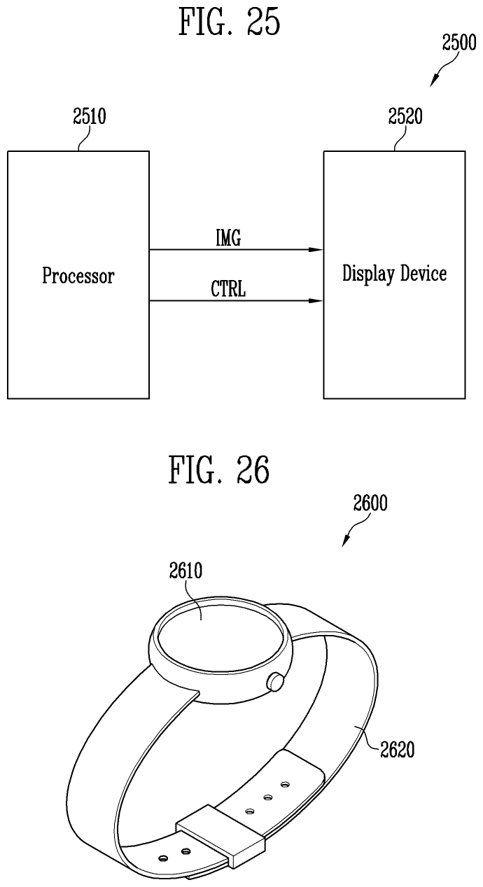

FIG. 24 is a schematic cross-sectional view taken along line II-II′ of FIG. 22.

Referring to FIGS. 22 and 24, the pixel circuit layer PCL, the display element layer DPL, and the light function layer LFL may be sequentially provided on the substrate SUB.

The pixel circuit layer PCL and the display element layer DPL may be similar to those described with reference to FIG. 23. In the pixel circuit layer PCL, sub-pixel circuits respectively corresponding to the first to third sub-pixels SP1 to SP3 may be provided. In the display element layer DPL, the first to third light emitting elements LD1 to LD3 respectively corresponding to the first to third sub-pixels SP1 to SP3 may be provided. The first to third light emitting elements LD1 to LD3 may overlap the first openings OP1 of the first bank BNK1 in a plan view. The first light emitting element LD1 may be connected between the cathode electrode CE (refer to FIG. 23) and the transistor T_SP1 (refer to FIG. 23) included in the sub-pixel circuit of the first sub-pixel SP1. The second light emitting element LD2 may be connected between the cathode electrode CE and a transistor included in the sub-pixel circuit of the second sub-pixel SP2. The third light emitting element LD3 may be connected between the cathode electrode CE and a transistor included in the sub-pixel circuit of the third sub-pixel SP3. Hereinafter, an overlapping description is omitted.

The light functional layer LFL may be provided on the display element layer DPL. The light functional layer LFL may be similar to that described with reference to FIG. 23. Hereinafter, an overlapping description is omitted.

The second bank BNK2 may have the second openings OP2. An emission area EMA and a non-emission area NEMA for the first to third sub-pixels SP1 to SP3 may be defined by the second bank BNK2. An area overlapping the second bank BNK2 in a plan view may correspond to the non-emission area NEMA. An area overlapping the second openings OP2 of the second bank BNK2 in a plan view may correspond to the emission area EMA of the first to third sub-pixels SP1 to SP3.

On the capping layer CPL, the fourth via layer PSV4 may be disposed in the second openings OP2. On the fourth via layer PSV4, first and second light conversion patterns CCP1 and CCP2 and a light scattering pattern LSP may be disposed in the second openings OP2.

In embodiments, the first to third light emitting elements LD1 to LD3 may be configured to emit light of a blue color. The first light conversion pattern CCP1 may include first color conversion particles QD1 configured to convert the light of the blue color into light of a red color. The second light conversion pattern CCP2 may include second color conversion particles QD2 configured to convert the light of the blue color into light of a green color. The light scattering pattern LSP may include scattering particles SCT that scatter the light of the blue color to improve light output efficiency. Accordingly, the first to third sub-pixels SP1 to SP3 may be provided as a red sub-pixel, a green sub-pixel, and a blue sub-pixel, respectively. In embodiments, at least one of the first and second light conversion patterns CCP1 and CCP2 and the light scattering pattern LSP may further include color conversion particles that convert the light of the blue color into light of a white color.

In embodiments, the first to third light emitting elements LD1 to LD3 may be configured to emit the light of the red color, the green color, and the blue color, respectively, and each of the first and second light conversion patterns CCP1 and CCP2 and the light scattering pattern LSP may include scattering particles SCT. As described above, particles included in the first and second light conversion patterns CCP1 and CCP2 and the light scattering pattern LSP may be variously changed according to the first to third light emitting elements LD1 to LD3.

In embodiments, the first and second light conversion patterns CCP1 and CCP2 and the light scattering pattern LSP may be omitted.

The low refractive layer LRL may be disposed on the second bank BNK2, the reflective layer RFL, the first light conversion pattern CCP1, the second light conversion pattern CCP2, and the light scattering pattern LSP. The low refractive layer LRL may have a refractive index lower than a refractive index of the first and second light conversion patterns CCP1 and CCP2 and the light scattering pattern LSP. In embodiments, the low refractive layer LRL may be omitted in an area corresponding to the third sub-pixel SP3.

The color filter layer CFL may be disposed on the low refractive layer LRL. The color filter layer CFL may include first to third color filters CF1 to CF3, and light blocking patterns LBP.

Each of the first to third color filters CF1 to CF3 may selectively transmit light of a desired wavelength range. In case that the first sub-pixel SP1 is a red sub-pixel, the first color filter CF1 may be a red color filter. In case that the second sub-pixel SP2 is a green sub-pixel, the second color filter CF2 may be a green color filter. In case that the third sub-pixel SP3 is a blue sub-pixel, the third color filter CF3 may be a blue color filter. The first to third color filters CF1 to CF3 may have a refractive index higher than the refractive index of the low refractive layer LRL. However, embodiments of the disclosure are not limited thereto. For example, at least one of the first to third color filters CF1 to CF3 may have a refractive index lower than or equal to the refractive index of the low refractive layer LRL.

The light blocking patterns LBP may be disposed between the first to third color filters CF1 to CF3. The emission area (or a light output area) EMA and the non-emission area NEMA for the first to third sub-pixels SP1 to SP3 may be defined by the light blocking patterns LBP. An area overlapping the light blocking patterns LBP in a plan view may correspond to the non-emission area NEMA. An area that does not overlap the light blocking patterns LBP in a plan view may correspond to the emission area EMA.

In embodiments, the light blocking patterns LBP may include at least one of various types of light blocking materials. In embodiments, each of the light blocking patterns LBP may be provided in a form of multiple layers in which at least two color filters among the first to third color filters CF1 to CF3 overlap. For example, each of the light blocking patterns LBP may be formed by stacking the first to third color filters CF1 to CF3 with each other. In another embodiment, a light blocking pattern between the first and second color filters CF1 and CF2 among the light blocking patterns LBP may be formed as multiple layers in which the first and second color filters CF1 and CF2 overlap in a plan view, and a light blocking pattern between the second and third color filters CF2 and CF3 among the light blocking patterns LBP may be formed as multiple layers in which the second and third color filters CF2 and CF3 overlap in a plan view.

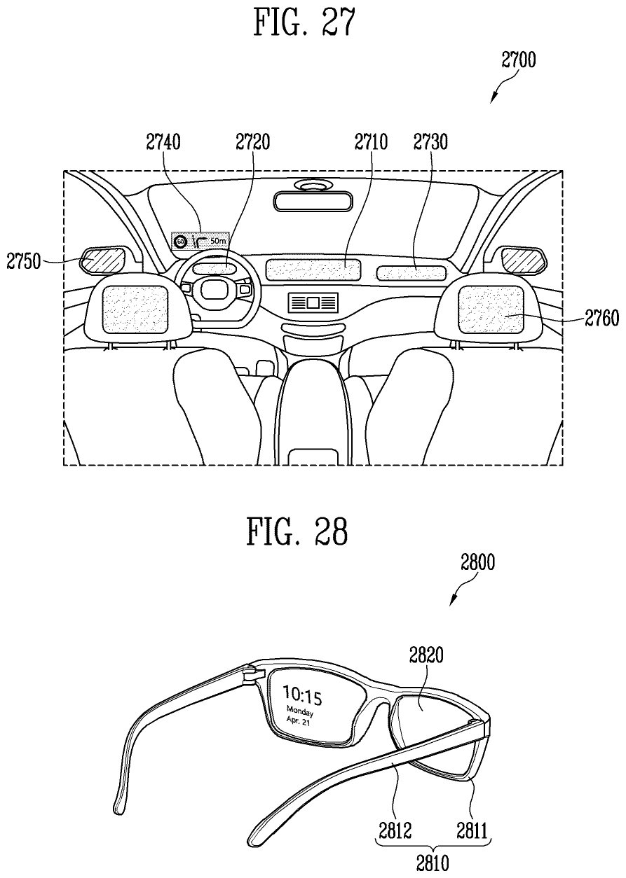

FIG. 25 is a schematic block diagram illustrating an embodiment of a display system 2500.

Referring to FIG. 25, the display system 2500 may include a processor 2510 and a display device 2520.

The processor 2510 may perform various tasks and calculations. In embodiments, the processor 2510 may include an application processor (AP), a graphics processing unit, a microprocessor, a central processing unit (CPU), and the like. The processor 2510 may be connected to other components of the display system 2500 through a bus system to control the other components.

The processor 2510 may transmit image data IMG and a control signal CTRL to the display device 2520. The display device 2520 may display an image based on the image data IMG and the control signal CTRL. The display device 2520 may be configured similarly to the display device DD described with reference to FIG. 1, and the image data IMG and the control signal CTRL may be provided as the input image data IMG and the control signal CTRL of FIG. 1, respectively.

The display system 2500 may include a computing system providing an image display function, and may be applied to a smart watch, a mobile phone, a smart phone, a portable computer, a tablet personal computer (PC), a watch phone, an automotive display, smart glasses, a portable multimedia player (PMP), a navigation device, or an ultra mobile personal computer (UMPC). The display system 2500 may be applied to at least one of a head mounted display (HMD) device, a virtual reality (VR) device, a mixed reality (MR) device, and an augmented reality (AR) device.

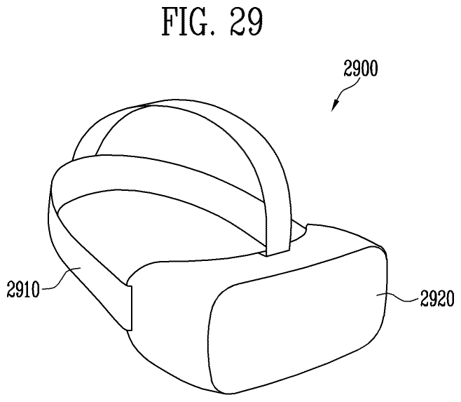

FIGS. 26 to 29 are perspective views illustrating application examples of the display system 2500 of FIG. 25.

Referring to FIG. 26, the display system 2500 of FIG. 25 may be applied to a smart watch 2600 including a display unit 2610 and a strap unit 2620.

The smart watch 2600 may be a wearable electronic device. For example, the smart watch 2600 may have a structure in which the strap unit 2620 is mounted on a user's wrist. Here, the display system 2500 and/or the display device 2520 may be applied to the display unit 2610, and image data including time information may be provided to a user.

Referring to FIG. 27, the display system 2500 of FIG. 25 may be applied to an automotive display system 2700. Here, the automotive display system 2700 may include a computing system provided inside and/or outside a vehicle to provide image data.

For example, the display system 2500 and/or the display device 2520 may be applied to at least one of an infotainment panel 2710, a cluster 2720, a co-driver display 2730, a head-up display 2740, a side mirror display 2750, and a rear seat displays 2760 provided in a vehicle.

Referring to FIG. 28, the display system 2500 of FIG. 25 may be applied to smart glasses 2800. The smart glasses 2800 may be a wearable electronic device that may be worn on a user's head. For example, the smart glasses 2800 may be a wearable device for augmented reality.

The smart glasses 2800 may include a frame 2810 and a lens unit 2820. The frame 2810 may include a housing 2811 that supports the lens unit 2820 and a leg unit 2812 for the user to wear. The leg unit 2812 may be connected to the housing 2811 through a hinge and may be folded or unfolded relative to the housing 2811.

A battery, a touch pad, a microphone, a camera, and the like may be built in the frame 2810. A projector that outputs light, a processor that controls a light signal, and the like may be built in the frame 2810.

The lens unit 2820 may include an optical member that transmits or reflects light. For example, the lens unit 2820 may include glass, a transparent synthetic resin, or the like.

In order for user's eyes to recognize visual information, the lens unit 2820 may reflect an image by the light signal transmitted from the projector of the frame 2810 on a rear surface (for example, a surface of a direction facing the user's eyes) of the lens unit 2820. For example, the user may recognize visual information such as time and date displayed on the lens unit 2820. The projector and/or the lens unit 2820 may be a type of display device. The display device 2520 (refer to FIG. 25) may be applied to the projector and/or the lens unit 2820.

Referring to FIG. 29, the display system 2500 of FIG. 25 may be applied to a head mounted display device 2900.

The head mounted display device 2900 may be a wearable electronic device that may be worn on a user's head. For example, the head mounted display device 2900 may be a wearable device for virtual reality or mixed reality.

The head mounted display device 2900 may include a head mount band 2910 and a display device receiving case 2920. The head mount band 2910 may be connected to the display device receiving case 2920. The head mount band 2910 may include a horizontal band and/or a vertical band for fixing the head mounted display device 2900 to a user's head. The horizontal band may be configured to surround a side portion of the user's head, and the vertical band may be configured to surround an upper portion of the user's head. However, embodiments are not limited thereto. For example, the head mount band 2910 may be implemented in a form of a glasses frame, a helmet, or the like.

The display device receiving case 2920 may house the display system 2500 and/or the display device 2520.

In accordance with the sub-pixel, the display device including the same, the display system including the same, and the method of driving the same according to embodiments of the disclosure may improve a problem in that a color coordinate is distorted may be improved.

The above description is an example of technical features of the disclosure, and those skilled in the art to which the disclosure pertains will be able to make various modifications and variations. Therefore, the embodiments of the disclosure described above may be implemented separately or in combination with each other.

Therefore, the embodiments disclosed in the disclosure are not intended to limit the technical spirit of the disclosure, but to describe the technical spirit of the disclosure, and the scope of the technical spirit of the disclosure is not limited by these embodiments. The protection scope of the disclosure should be interpreted by the following claims, and it should be interpreted that all technical spirits within the equivalent scope are included in the scope of the disclosure.

What is claimed is:

1. A display device comprising a sub-pixel, wherein the sub-pixel comprises:
a first transistor including a gate electrode connected to a first node, a source electrode connected to a first power line to which a first power voltage is applied, a body electrode connected to the source electrode, and a drain electrode connected to a second node;
a second transistor that switches an electrical connection between a third node and a data line and including a gate electrode electrically connected to a first sub-scan line;
a third transistor connected to the first node and including a gate electrode connected to the third node;
a fourth transistor that switches an electrical connection between the first node and the second node and including a gate electrode connected to a second sub-scan line;
a first capacitor including a first electrode electrically connected to the first node and a second electrode connected to a second power line to which a second power voltage is applied;
a second capacitor including a first electrode electrically connected to the third node and a second electrode connected to a sweep line to which a sweep signal is applied; and
a light emitting element connected between the second node and a third power line to which a third power voltage is applied.

2. The display device according to claim 1, wherein the first power voltage has one of a low level, a middle level, and a high level.

3. The display device according to claim 2, wherein a driving current flowing in a direction from the first transistor to the light emitting element is proportional to a square of a voltage difference between the middle level and the high level of the first power voltage.

4. The display device according to claim 1, wherein
in at least a portion of a period in which a second scan signal of a turn-on level is applied to the second sub-scan line, the first power voltage has a low level, and
in a remaining portion of the period in which the second scan signal of the turn-on level is applied to the second sub-scan line, the first power voltage has a middle level.

5. The display device according to claim 4, wherein in the period in which the second scan signal of the turn-on level is applied to the second sub-scan line and the first power voltage has the low level, a voltage of the first node is initialized.

6. The display device according to claim 4, wherein in the period in which the second scan signal of the turn-on level is applied to the second sub-scan line and the first power voltage has the middle level, a voltage in which a change of a threshold voltage of the first transistor is reflected is stored in the first node.

7. The display device according to claim 1, wherein in case that a first scan signal of a turn-on level is applied to the first sub-scan line, the third node and the data line are electrically connected.

8. The display device according to claim 1, wherein in a period in which the third power voltage transits from a high level to a low level and a voltage level of the sweep signal decreases from a high level to a low level, in case that a voltage of a turn-on level is applied to the third transistor, the first transistor is turned off.

9. The display device according to claim 1, wherein the sub-pixel emits light having luminance according to a duration of time in which a driving current flows in a direction from the first transistor to the light emitting element.

10. The display device according to claim 1, wherein the third transistor is connected between the first power line and the first node, and includes a body electrode connected to the first power line.

11. The display device according to claim 1, wherein the third transistor is connected between the second power line and the first node, and includes a body electrode connected to the first power line.

12. The display device according to claim 1, wherein each of the first transistor, the third transistor, and the fourth transistor includes a P-type semiconductor.

13. The display device according to claim 11, wherein the second transistor includes a P-type semiconductor, and includes a body electrode connected to the second power line.

14. The display device according to claim 11, wherein the second transistor includes an N-type semiconductor, and includes a body electrode connected to a fourth power line.

15. The display device according to claim 1 further comprising:
a display panel in which a plurality of sub-pixels including the sub-pixel are disposed;
a gate driver that supplies a first scan signal and a second scan signal to the plurality of sub-pixels;
a sweep supply circuit that supplies the sweep signal to the plurality of sub-pixels;
a data driver that supplies a data voltage to the plurality of sub-pixels; and
a voltage generator that supplies the first power voltage, the second power voltage, and the third power voltage to the plurality of sub-pixels.

16. The display device according to claim 15, wherein
the voltage generator is supplied with a driving voltage, a ground voltage, and a voltage control signal, and
the voltage generator outputs the first power voltage having one of a low level, a middle level, and a high level in response to the voltage control signal.

17. A method of driving a display device, the method comprising:
applying a first power voltage of a low level to a source electrode and a body electrode of a driving transistor, and electrically separating a gate electrode and a drain electrode of the driving transistor from each other;
applying the first power voltage of the low level to the source electrode and the body electrode of the driving transistor, and electrically connecting the gate electrode and the drain electrode of the driving transistor to each other;
applying the first power voltage of a middle level to the source electrode and the body electrode of the driving transistor, and electrically connecting the gate electrode and the drain electrode of the driving transistor to each other;
applying a data voltage to a first electrode of a sweep capacitor in case that the gate electrode and the drain electrode of the driving transistor are electrically separated from each other and a switching transistor is turned on; and
applying the first power voltage of a high level to the source electrode and the body electrode of the driving transistor, and causing a light emitting element connected between the drain electrode of the driving transistor and a power line to emit light.

18. The method according to claim 17, wherein in the causing of the light emitting element to emit light,
in case that a voltage level of a sweep signal applied to a second electrode of the sweep capacitor decreases from a high level to a low level, and an emission control transistor including a gate electrode connected to the first electrode of the sweep capacitor is turned on, a second power voltage is applied to the gate electrode of the driving transistor, and the driving transistor is turned off.

19. The method according to claim 17, wherein in the causing of the light emitting element to emit light,
a driving current flowing through the light emitting element is based on a wavelength band of light emitted from the light emitting element.

20. A display system comprising:
a processor that transmits input image data;
a display panel in which a plurality of sub-pixels are disposed;
a gate driver that supplies a first scan signal and a second scan signal to the plurality of sub-pixels;
a sweep supply circuit that supplies a sweep signal to the plurality of sub-pixels;
a data driver that supplies a data voltage corresponding to the input image data to the plurality of sub-pixels; and
a voltage generator that supplies a first power voltage, a second power voltage, and a third power voltage to the plurality of sub-pixels,
wherein at least one of the plurality of sub-pixels comprises:
a first transistor including a gate electrode connected to a first node, a source electrode connected to a first power line to which the first power voltage is applied, a body electrode connected to the source electrode, and a drain electrode connected to a second node;
a second transistor that switches an electrical connection between a third node and a data line to which the data voltage is applied and including a gate electrode to which the first sub-scan signal is applied;
a third transistor connected to the first node and including a gate electrode connected to the third node;
a fourth transistor that switches an electrical connection between the first node and the second node and including a gate electrode to which the second sub-scan signal is applied;
a first capacitor including a first electrode electrically connected to the first node and a second electrode to which the second power voltage is applied;
a second capacitor including a first electrode electrically connected to the third node and a second electrode to which the sweep signal is applied; and
a light emitting element connected between the second node and a second power line to which the third power voltage is applied.
